(19) United States
(12) Patent Application Publication
(10) Pub. No.: US 2013/0004206 A1
(43) Pub. Date: Jan. 3, 2013

(54) CHARGING MEMBER, PROCESS CARTRIDGE AND ELECTROPHOTOGRAPHIC APPARATUS

(75) Inventors: Noriaki Kuroda, Suntou-gun (JP); Masataka Kodama, Mishima-shi (JP); Noriko Suzumura, Mishima-shi (JP); Yuya Tomomizu, Suntou-gun (JP); Hiroki Masu, Numazu-shi (JP)

(73) Assignee: CANON KABUSHIKI KAISHA, Tokyo (JP)

(21) Appl. No.: 13/615,380

(22) Filed: Sep. 13, 2012

Related U.S. Application Data
(63) Continuation of application No. PCT/JP2012/002686, filed on Apr. 18, 2012.

(30) Foreign Application Priority Data
Apr. 25, 2011 (JP) 2011-097477

(51) Int. Cl. G03G 15/02

(52) U.S. Cl. 399/176

(57) ABSTRACT

A charging member for electrophotographic apparatus is provided which has a superior charging performance for the electrophotographic photosensitive member and also can not easily change with time in charging performance. The charging member has a substrate, an elastic layer and a surface layer, which surface layer contains a high-molecular compound having an Si—O—Ti linkage in the molecular structure and a cyclic polysilane represented by the general formula (7) defined in the specification, and the high-molecular compound has a constituent unit represented by the general formula (1) and a constituent unit represented by the following formula (2) which are defined in the specification.

### CROSS-REFERENCE TO RELATED APPLICATIONS

This application is a continuation of International Application No. PCT/JP2012/002686, filed Apr. 18, 2012, which claims the benefit of Japanese Patent Application No. 2011-097477, filed Apr. 25, 2011.

### BACKGROUND OF THE INVENTION

1. Field of the Invention

This invention relates to a charging member used in contact charging of electrophotographic apparatus, and to a process cartridge and an electrophotographic apparatus.

2. Related Background Art

A charging member provided in contact with an electrophotographic photosensitive member to charge the electrophotographic photosensitive member electrostatically is commonly so constituted as to have an elastic layer containing a rubber, in order to sufficiently and uniformly secure a contact nip between the electrophotographic photosensitive member and the charging member. In such an elastic layer, a low-molecular weight component is inevitably contained, and hence the low-molecular weight component may exude to the surface of the charging member as a result of long-term service to contaminate the surface of the electrophotographic photosensitive member. To cope with such a phenomenon, Japanese Patent Application Laid-Open No. 2001-173641 discloses the constitution that the elastic layer is covered on its periphery with an inorganic oxide film or an organic-inorganic hybrid film so as to keep the low-molecular weight component from exuding to the surface of the charging member.

Now, as electrophotographic image formation processes have become higher in speed and apparatus therefor have become longer in lifetime in recent years, the time for contact between the electrophotographic photosensitive member and the charging member has become relatively short, and this trends disadvantageously for charging the electrophotographic photosensitive member stably and surely.

In addition, in charging the surface of the electrophotographic photosensitive member, the charging member also lies in an environment where its surface tends to be oxidized. Hence, where the charging member is continued being used over a long period of time, the surface of the charging member may be oxidized to come to deteriorate gradually and change with time in charging performance.

### SUMMARY OF THE INVENTION

Accordingly, the present invention is directed to providing a charging member having a superior charging performance for the electrophotographic photosensitive member and also can not easily change with time in charging performance.

Further, the present invention is directed to providing an electrophotographic apparatus and a process cartridge which enable stable formation of high-grade electrophotographic images.

### Solution to Problem

According to one aspect of the present invention, there is provided a charging member for electrophotographic apparatus, the charging member is provide with a substrate, an elastic layer and a surface layer, wherein said surface layer comprises a high-molecular compound having an Si—O—Ti linkage in the molecular structure, and a cyclic polysilane represented by the following general formula (7), and the high-molecular compound has a constituent unit represented by the following general formula (1) and a constituent unit represented by the following formula (2).

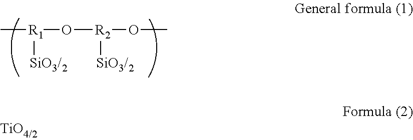

In the general formula (1), R₁ and R₂ each independently represent any structure selected from structures represented by the following general formulas (3) to (6).

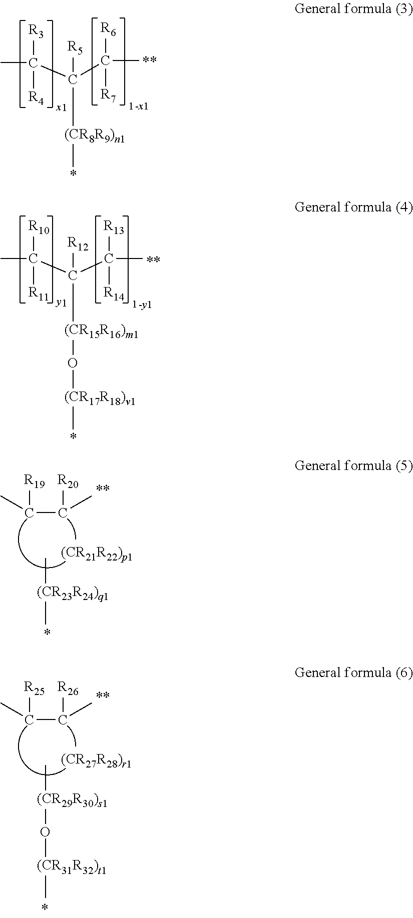

In the general formulas (3) to (6), R₃ to R₇, R₁₀ to R₁₄, R₁₉, R₂₀, R₂₅ and R₂₆ each independently represent a hydrogen atom, a straight-chain or branched-chain alkyl group having 1 to 4 carbon atom(s), a hydroxyl group, a carboxyl group or an amino group; R₈, R₉, R₁₅ to R₁₈, R₂₃, R₂₄ and R₂₉ to R₃₂ each independently represent a hydrogen atom or a straight-chain or branched-chain alkyl group having 1 to 4 carbon atom(s); R₂₁, R₂₂, R₂₇ and R₂₈ each independently represent a hydrogen atom, an alkoxy group having 1 to 4 carbon atom(s) or a straight-chain or branched-chain alkyl group having 1 to 4 carbon atom(s); n1, m1, q1, s1, t1 and v1 each independently represent an integer of 1 to 8, p1 and r1 each independently represent an integer of 4 to 12, and x1 and y1 each independently represent 0 or 1; and an asterisk * and a double asterisk ** each represent the position of bonding with the silicon atom and oxygen atom, respectively, in the general formula (1).

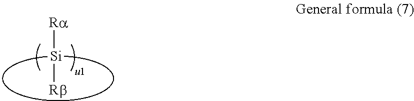

In the general formula (7), R_{α} and R_{β} each independently represent a hydrogen atom, a hydroxyl group, an alkyl group, an alkoxy group, an alkenyl group, a cycloalkyl group, a cycloalkyloxy group, a cycloalkenyl group, an aryl group, an aryloxy group or a silyl group; and u1 represent an integer of 4 to 12.

According to another aspect of the present invention, there is provided an electrophotographic apparatus which has an electrophotographic photosensitive member and the above charging member, disposed in contact with the electrophotographic photosensitive member.

According to further aspect of the present invention, there is provided a process cartridge which has an electrophotographic photosensitive member and the above charging member, disposed in contact with the electrophotographic photosensitive member, and is so set as to be detachably mountable to the main body of an electrophotographic apparatus.

### Advantageous Effects of Invention

According to the present invention, a charging member can also be obtained which has a superior charging performance for the electrophotographic photosensitive member and also can not easily change with time in charging performance.

According to the present invention, an electrophotographic apparatus and a process cartridge can also be obtained which enable stable formation of high-grade electrophotographic images.

Further features of the present invention will become apparent from the following description of exemplary embodiments with reference to the attached drawings.

### BRIEF DESCRIPTION OF THE DRAWINGS

FIG. 1 is a sectional view showing an example of the charging member according to the present invention.

FIG. 2 is a diagrammatic view of the electrophotographic apparatus according to the present invention.

FIG. 3 is a chart showing the results of measurement by ²⁹Si-NMR of a high-molecular compound.

FIG. 4 is a chart showing the results of measurement by ¹³C-NMR of a high-molecular compound.

FIG. 5A is a chart showing the results of measurement by ESCA of a surface layer of the charging member according to the present invention.

FIG. 5B is a chart showing the results of measurement by ESCA of a surface layer of the charging member according to the present invention.

FIG. 6A is a chart showing the results of measurement by XRD of a surface layer of the charging member according to the present invention.

FIG. 6B is a chart showing the results of measurement by XRD of a surface layer of the charging member according to the present invention.

FIG. 7 is an illustration relating to cross-linking reaction when a surface layer is formed.

### DESCRIPTION OF THE EMBODIMENTS

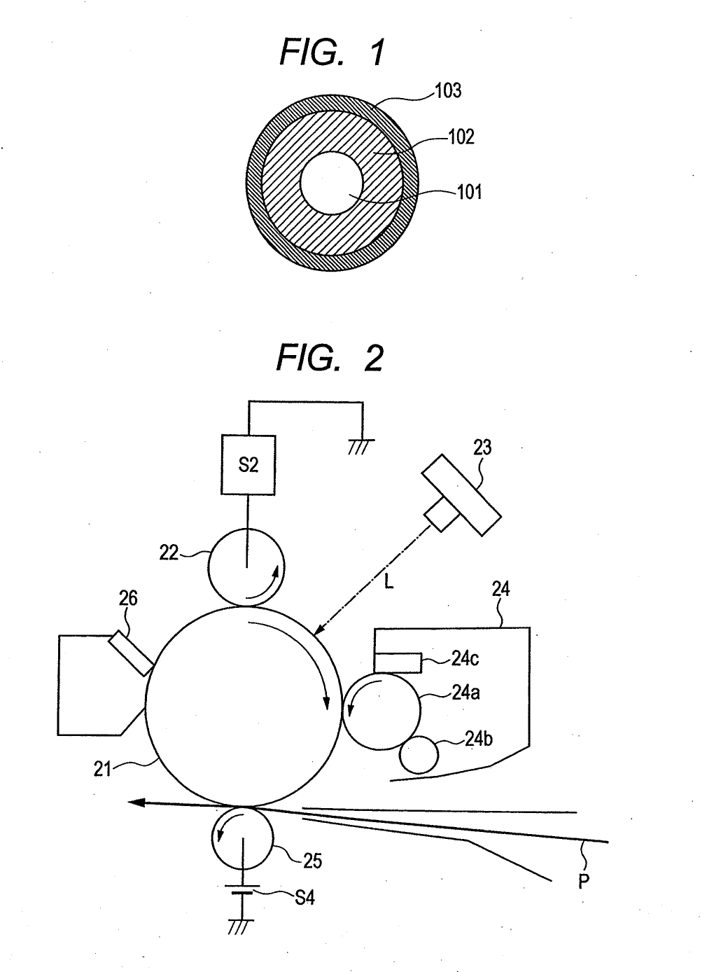

The charging member according to the present invention contains a high-molecular compound detailed later and a cyclic polysilane. The charging member of the present invention may also have a surface layer containing the high-molecular compound and the cyclic polysilane, and may be constituted of, as shown in FIG. 1, a substrate 101, an electrically conductive elastic layer 102 and as the above surface layer a surface layer 103. The charging member is described below taking note of this constitution.

The charging member for electrophotographic apparatus of the present invention may also be used as a charging roller, having the shape of a roller as shown in the drawing, and besides one having the shape of a belt (charging belt), one having the shape of a blade (charging blade) or one having the shape of a brush (charging brush).

Substrate

As the substrate, a substrate made of a metal (or made of an alloy) such as iron, copper, stainless steel, aluminum, an aluminum alloy or nickel (e.g., a columnar metal substrate) may be used.

Elastic Layer

As the elastic layer, any elastic layer of conventional charging members for electrophotographic apparatus may be used. As materials constituting the elastic layer, one or two or more of elastic materials such as rubbers or thermoplastic elastomers may be used which are described below.

The rubbers may include the following: Urethane rubbers, silicone rubbers, butadiene rubbers, isoprene rubbers, chloroprene rubbers, styrene-butadiene rubbers, ethylene-propylene rubbers, styrene-butadiene-styrene rubbers, acrylonitrile rubbers, epichlorohydrin rubbers and alkyl ether rubbers. Also, the thermoplastic elastomers may include the following: Styrene type elastomers and olefin type elastomers.

Besides any of the above rubbers or thermoplastic elastomers, the elastic layer may also contain a conducting agent. This can make up the elastic layer as a conductive elastic layer, having electrical conductivity. The elastic layer may preferably have an electrical resistance value of from 10²Ω or more to 10⁸Ω or less, and much preferably from 10³Ω or more to 10⁶Ω or less. The conducting agent used in the elastic layer may include, e.g., cationic surface-active agents, anionic surface-active agents, antistatic agents and electrolytes.

The cationic surface-active agents may include the following: Salts of quaternary ammoniums such as lauryl trimethylammonium, stearyl trimethylammonium, octadodecyl trimethylammonium, dodecyl trimethylammonium, hexadecyl trimethylammonium, and modified fatty acid dimethyl ethylammonium; perchlorates, chlorates, tetrafluoroborates, ethosulfates, and benzyl halides such as benzyl bromide and benzyl chloride.

The anionic surface-active agents may include the following: Aliphatic sulfonates, higher alcohol sulfates, higher alcohol ethylene oxide addition sulfates, higher alcohol phosphates, and higher alcohol ethylene oxide addition phosphates.

The antistatic agents may include, e.g., nonionic antistatic agents such as higher alcohol ethylene oxides, polyethylene glycol fatty esters, and polyhydric alcohol fatty esters.

The electrolytes may include, e.g., salts (such as quaternary ammonium salts) of metals belonging to Group 1 of the periodic table (such as Li, Na and K). The salts of metals belonging to Group 1 of the periodic table may specifically include LiCF₃SO₃, NaClO₄, LiAsF₆, LiBF₄, NaSCN, KSCN and NaCl.

As the conducting agent for the elastic layer, also usable are salts (such as Ca(ClO₄)₂) of metals belonging to Group 2 of the periodic table (such as Ca and Ba), and antistatic agents derived therefrom. Still also usable are ion-conductive conducting agents such as complexes of any of these with polyhydric alcohols (such as 1,4-butanediol, ethylene glycol, polyethylene glycol, propylene glycol and polyethylene glycol) or derivatives thereof, and complexes of any of these with monools (such as ethylene glycol monomethyl ether and ethylene glycol monoethyl ether).

As the conducting agent for the elastic layer, also usable are carbon type materials such as conductive carbon black and graphite; metal oxides such as tin oxide, titanium oxide and zinc oxide; metals such as nickel, copper, silver and germanium.

The elastic layer may preferably have a hardness, as MD-1 hardness, of 60 degrees or more to 85 degrees or less, and particularly from 70 degrees or more to 80 degrees or less, from the viewpoint of keeping the charging member from deforming when the charging member and the charging object member electrophotographic photosensitive member are brought into contact with each other. The MD-1 hardness may be measured by bringing an indenter point of an MD-1 type hardness meter (manufactured by Kobunshi Keiki Co., Ltd.) into contact with the surface of the measuring object in a measurement environment of 25° C./55% RH (relative humidity).

In order to make the elastic layer come into contact with the photosensitive member uniformly in the width direction, the elastic layer may also preferably be in what is called a crown shape in which it is larger in thickness at its middle in the width direction than at its end portions.

Surface Layer

The surface layer of the charging member according to the present invention may contain the high-molecular compound having an Si—O—Ti linkage (hereinafter also simply “high-molecular compound”), and the cyclic polysilane represented by the general formula (7) as will be detailed later.

High-Molecular Compound

The high-molecular compound used in the present invention has an Si—O—Ti linkage in the molecular structure, and also has both a constituent unit represented by the following general formula (1) and a constituent unit represented by the following formula (2).

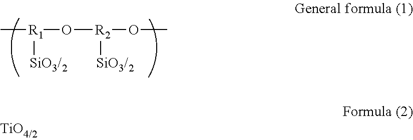

In the general formula (1), R₁ and R₂ each independently represent any structure selected from structures represented by the following general formulas (3) to (6).

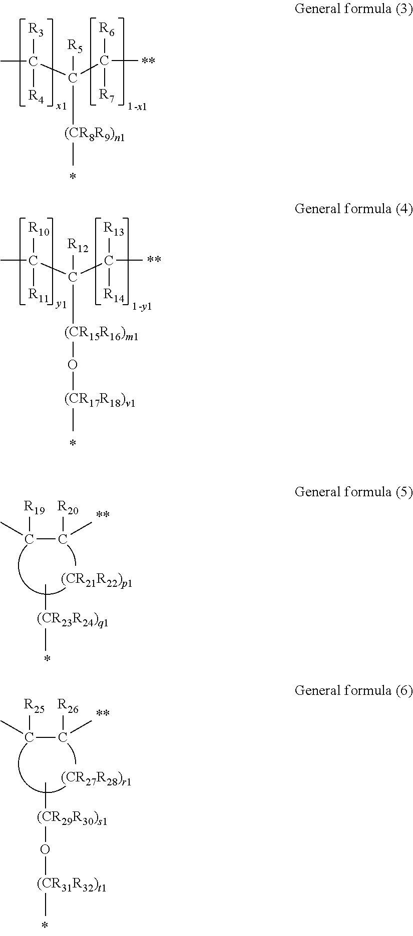

In the general formulas (3) to (6), R₃ to R₇, R₁₀ to R₁₄, R₁₉, R₂₀, R₂₅ and R₂₆ each independently represent a hydrogen atom, a straight-chain or branched-chain alkyl group having 1 to 4 carbon atom(s), a hydroxyl group, a carboxyl group or an amino group;

R₈, R₉, R₁₅ to R₁₈, R₂₃, R₂₄ and R₂₉ to R₃₂ each independently represent a hydrogen atom or a straight-chain or branched-chain alkyl group having 1 to 4 carbon atom(s); and
R₂₁, R₂₂, R₂₇ and R₂₈ each independently represent a hydrogen atom, an alkoxy group having 1 to 4 carbon atom(s) or a straight-chain or branched-chain alkyl group having 1 to 4 carbon atom(s).

At least one of CR₈R₉, CR₁₅R₁₆, CR₁₇R₁₈, CR₂₃R₂₄, CR₂₈R₃₀ and CR₃₁R₃₂ may also be a carbonyl group.

At least one pair selected from the group consisting of the following pairs may further combine with each other to form a ring structure.

A pair of R₃ and R₄; a pair of R₆ and R₇; a pair of R₁₀ and R₁₁; a pair of R₁₃ and R₁₄; a pair of any one of R₃, R₄, R₆ and R₇, and R₅; a pair of any one of R₁₀, R₁₁, R₁₃ and R₁₄, and R₁₂; a pair of R₅ and the carbon atom in (CR₈R₉)ₙ₁; and a pair of R₁₂ and the carbon atom in (CR₁₅R₁₆)ₘ₁.

Symbols n1, m1, q1, s1, t1 and v1 each independently represent an integer of 1 to 8, p1 and r1 each independently represent an integer of 4 to 12, and x1 and y1 each independently represent 0 or 1; and an asterisk * and a double asterisk ** each represent the position of bonding with the silicon atom and oxygen atom, respectively, in the general formula (1).

An example of part of structure of the high-molecular compound used in the present invention, formed when R₁ in the general formula (1) is the structure represented by the general formula (3) and R₂ is the structure represented by the general formula (4) is shown below.

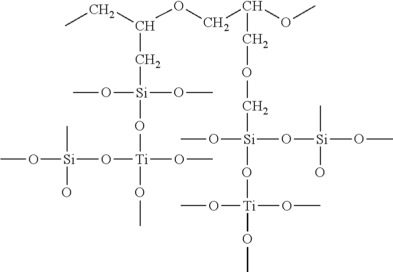

An example of part of structure of the high-molecular compound used in the present invention, formed when R₁ in the general formula (1) is the structure represented by the general formula (3) and R₂ is the structure represented by the general formula (6) is shown below.

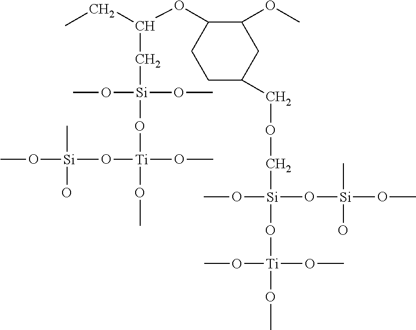

The high-molecular compound used in the present invention has the constituent unit represented by the general formula (1) and can have a structure wherein siloxane linkages and organic chain moieties bonded to Si's stand alternately polymerized, and hence can easily be made to have a high cross-link density. Incidentally, what is meant by SiO_{3/2} is that Si stands three-dimensionally cross-linked.

In addition, inasmuch as it has the Si—O—Ti linkage in the molecular structure, it can be more improved in the rate of condensation of Si than any high-molecular compounds produced from only a hydrolyzable silane compound. Hence, the surface layer containing the high-molecular compound used in the present invention is so dense as to be able to keep the low-molecular weight component from bleeding from the conductive elastic layer.

Further, the surface layer can contain an inorganic compound having the structural unit TiO_{4/2} represented by the formula (2), and hence can have a charging performance superior enough to cope with any electrophotographic processes having become higher in speed. The structure represented by the formula (2) may be formed by producing the high-molecular compound by using a titanium compound having a high dielectric constant (relative permittivity) for a metal oxide. More specifically, the TiO_{4/2} may be a structure derived from a titanium oxide. What is meant by the TiO_{4/2} is that the four reactive sites of Ti stand all reacted.

The Si—O—Ti linkage may be constituted of the SiO_{3/2} in the general formula (1) and the TiO_{4/2} of the formula (2).

Incidentally, the charging ability of the surface layer may be controlled also by selecting the types and amounts of organic chains bonded to the Si atoms, in addition to the ratio of Ti atoms to Si atoms of the high-molecular compound used in the present invention.

Where an oxide is used as a Ti material of this high-molecular compound, it is preferable to use one not having any perfect crystal structure (such as a rutile type or an anatase type). This makes it easy to keep the material from its sedimentation and agglomeration, and can provide a coating material having a superior stability.

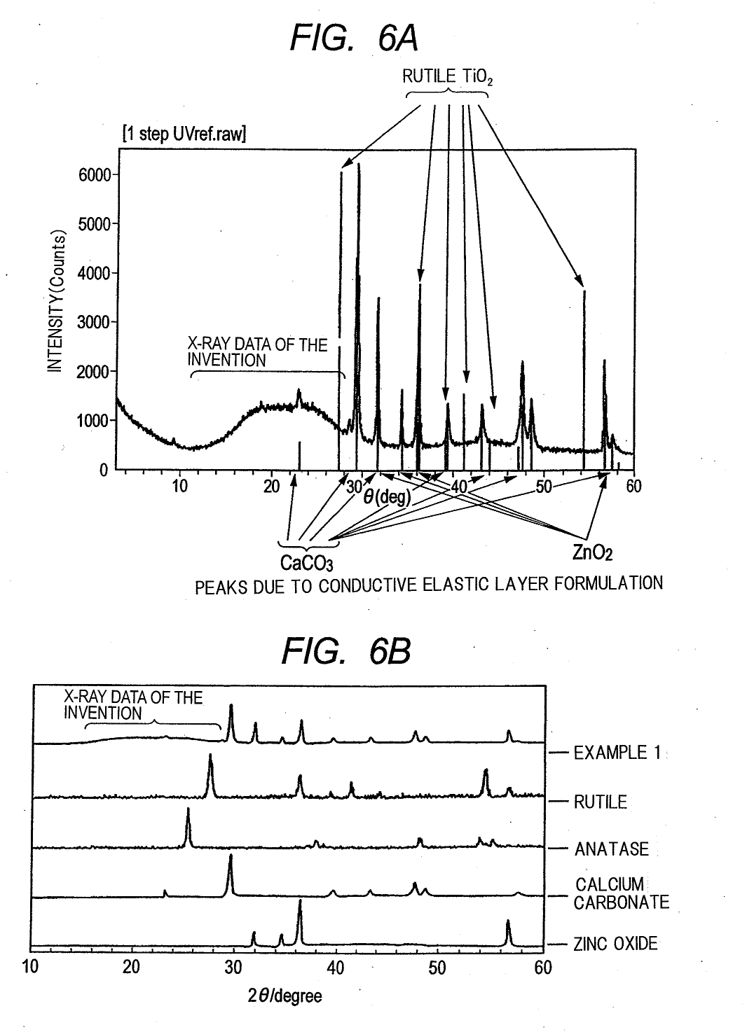

A result obtained by observing on an X-ray instrument (trade name: RINT TTR-II; manufactured by Rigaku Corporation) the surface of an example of the charging member of the present invention, containing CaCO₃ and ZnO₂ in its conductive elastic layer, is shown in FIG. 6A. In this chart, as shown in FIG. 6B, peaks due to CaCO₃ and ZnO₂ which are compounded in the conductive elastic layer are observable, but any peaks are not present at positions corresponding to the peaks of Ti oxides that are due to rutile and anatase crystal structures, and it is seen that a Ti oxide standing amorphous is used.

In the high-molecular compound used in the present invention, it is also preferable that R₁ and R₂ in the general formula (1) are each independently any structure selected from structures represented by the following general formulas (8) to (11). Making them have such structures can make the surface layer tougher and superior in durability.

Structures having an ether group as represented by the following general formulas (9) to (11) each can make the surface layer more improved in its adherence to the elastic layer, and are particularly preferred.

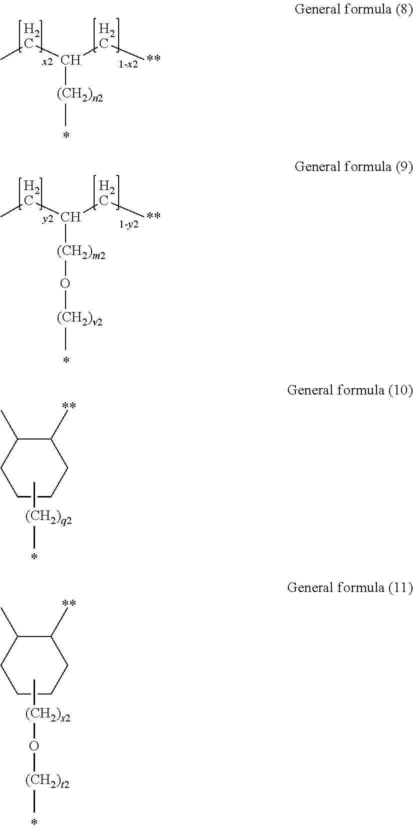

In the general formulas (8) to (11), n2, m2, q2, s2, t2 and v2 each independently represent an integer of 1 to 8, and x2 and y2 each independently represent 0 or 1. An asterisk * and a double asterisk ** each represent the position of bonding with the silicon atom and oxygen atom, respectively, in the general formula (1).

In the high-molecular compound, the ratio of the number of atoms of titanium to that of silicon, Ti/Si, may preferably be from 0.1 or more to 12.5 or less. This enables the charging member to be easily improved in its charging performance.

The high-molecular compound used in the present invention may also preferably be a cross-linked product (first cross-linked product) of a hydrolyzable compound having a structure represented by the following general formula (12) and a hydrolyzable compound having a structure represented by the following general formula (13). The first cross-linked product may be obtained by polymerizing (cross-linking) a condensate (first condensate) obtained by subjecting the hydrolyzable compound having a structure represented by the general formula (12) and the hydrolyzable compound having a structure represented by the general formula (13), to hydrolysis and condensation reaction. On this occasion, epoxy groups in what is represented by R₃₃ in the general formula (12) polymerize with one another, whereby first cross-linked products are cross-linked with one another. Also, ultraviolet rays may be used in the cross-linking.

The use of the above hydrolyzable compound enables easy control of the degree of hydrolysis and condensation taking place at the trifunctional moiety (OR₃₄-OR₃₆) of what is represented by the general formula (12) and the tetrafunctional moiety (OR₃₇-OR₄₀) of what is represented by the general formula (13), and enables easy control of the modulus of elasticity and denseness as film properties. Also, the organic-chain moiety of R₃₃ in the general formula (12) may be used as a curing site. This enables easy control of the toughness of the surface layer and the adherence of the surface layer to the elastic layer.

R₃₃ may also be set to be an organic group having an epoxy group capable of ring-opening by irradiation with ultraviolet rays, as sown in the general formulas (14) to (17) below. This can make curing time very shorter than that for any conventional heat-curable materials, and can easily keep the elastic layer from deteriorating thermally.

R₃₃—Si(OR₃₄)(OR₃₅)(OR₃₆) General formula (12)

In the general formula (12), R₃₃ represents any structure selected from structures represented by the following general formulas (14) to (17) each; and R₃₄ to R₃₆ each independently represent a straight-chain or branched-chain alkyl group having 1 to 4 carbon atom(s).

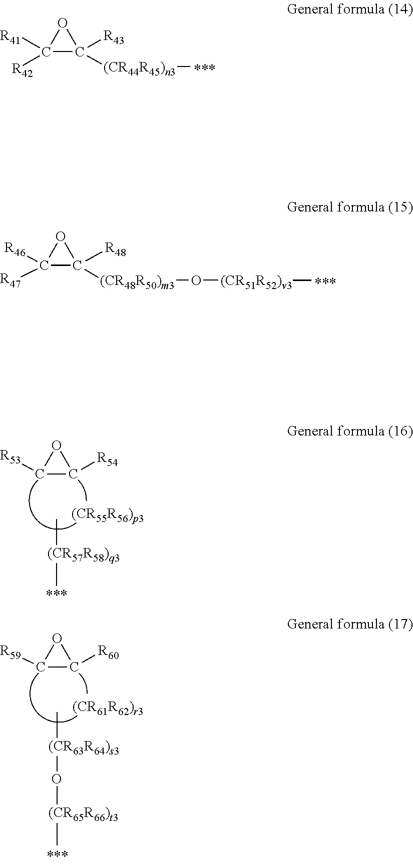

In the general formulas (14) to (17), R₄₁ to R₄₃, R₄₆ to R₄₈, R₅₃, R₅₄, R₅₉ and R₆₀ each independently represent a hydrogen atom, a straight-chain or branched-chain alkyl group having 1 to 4 carbon atom(s), a hydroxyl group, a carboxyl group or an amino group; R₄₄, R₄₅, R₄₉ to R₅₂, R₅₇, R₅₈ and R₆₃ to R₆₆ each independently represent a hydrogen atom or a straight-chain or branched-chain alkyl group having 1 to 4 carbon atom(s); R₅₅, R₅₆, R₆₁ and R₆₂ each independently represent a hydrogen atom, an alkoxy group having 1 to 4 carbon atom(s) or a straight-chain or branched-chain alkyl group having 1 to 4 carbon atom(s); and a triple asterisk *** represents the position of bonding with the silicon atom in the formula (12).

At least one of CR₄₄R₄₅, CR₄₉R₅₀, CR₅₁R₅₂, CR₅₇R₅₈, CR₆₃R₆₄ and CR₆₅R₆₆ may also be a carbonyl group.

At least one pair selected from the group consisting of the following pairs may further combine with each other to make a ring to form a cycloalkane:

A pair constituted of at least any two of the carbon atom in (CR₄₄R₄₅)ₙ₃, R₄₁, R₄₂ and R₄₃; a pair constituted of at least any two of the carbon atom in (CR₄₉R₅₀)ₘ₃, R₄₆, R₄₇ and R₄₈; a pair of R₅₃ and R₅₄; and a pair of R₅₉ and R₆₀.

Symbols n3, m3, q3, s3, t3 and v3 each independently represent an integer of 1 to 8, and p3 and r3 each independently represent an integer of 4 to 12;

Specific examples of such a hydrolyzable silane compound (component A) having the structure represented by the general formula (12) are shown below:
(A-1) 4-(1,2-Epoxybutyl)trimethoxysilane;
(A-2) 5,6-epoxyhexyltriethoxysilane;
(A-3) 8-oxysilan-2-yl octyltrimethoxysilane;
(A-4) 8-oxysilan-2-yl octyltriethoxysilane;
(A-5) 3-glycidoxypropyltrimethoxysilane;
(A-6) 3-glycidoxypropyltriethoxysilane;
(A-7) 1-(3,4-epoxycyclohexyl)ethyltrimethoxysilane;
(A-8) 1-(3,4-epoxycyclohexyl)ethyltriethoxysilane;
(A-9) 3-(3,4-epoxycyclohexyl)methyloxypropyltrimethoxy-silane; and
(A-10) 3-(3,4-epoxycyclohexyl)methyloxypropyltriethoxy-silane.

Ti(OR₃₇)(OR₃₈)(OR₃₉)(OR₄₀) General formula (13)

In the general formula (13), R₃₇ to R₄₀ each independently represent a straight-chain or branched-chain alkyl group having 1 to 9 carbon atom(s).

Specific examples of such a hydrolyzable titanium compound (component C) having the structure represented by the general formula (13) are shown below:
(C-1) Tetraethoxytitanium;
(C-2) tetra-1-propoxytitanium;
(C-3) tetra-n-butoxytitanium;
(C-4) tetra-t-butoxytitanium;
(C-5) 2-ethylhexoxytitanium; and
(C-6) 2-methoxyethyl-2-propoxytitanium.

The high-molecular compound used in the present invention may also preferably be a cross-linked product (second cross-linked product) of the hydrolyzable compound represented by the general formula (12) and the hydrolyzable compound represented by the general formula (13) with a hydrolyzable compound represented by the following general formula (18). In this case, the solubility of the general formulas (12) and (13) compounds in the stage of synthesis, the coating performance of a surface layer coating solution and, as physical properties of a film having been cured, the electrical properties of the surface layer can easily be improved, as being preferable.

The second cross-linked product may be obtained by polymerizing (cross-linking) a condensate (second condensate) obtained by subjecting the general formula (12) hydrolyzable compound, the general formula (13) hydrolyzable compound and the general formula (18) hydrolyzable compound to hydrolysis and condensation reaction.

R₆₇—Si(OR₆₈)(OR₆₉)(OR₇₀) General formula (18)

In the formula (18), R₆₇ represents a straight-chain or branched-chain alkyl group having 1 to 4 carbon atom(s) or a phenyl group; and R₆₈ to R₇₀ each independently represent a straight-chain or branched-chain alkyl group having 1 to 6 carbon atom(s). A case in which R₆₇ is an alkyl group is preferable as being able to improve the solubility and coating performance. A case in which R₆₇ is a phenyl group is also preferable as being contributory to an improvement in the electrical properties, in particular, volume resistivity.

Specific examples of such a hydrolyzable silane compound (component B) represented by the general formula (18) are shown below:
(B-1) Methyltrimethoxysilane;
(B-2) methyltriethoxysilane;
(B-3) ethyltrimethoxysilane;
(B-4) ethyltriethoxysilane;
(B-5) propyltrimethoxysilane;
(B-6) propyltriethoxysilane;
(B-7) hexyltrimethoxysilane;
(B-8) hexyltriethoxysilane;
(B-9) hexyltripropoxysilane;
(B-10) decyltrimethoxysilane;
(B-11) decyltriethoxysilane;
(B-12) phenyltrimethoxysilane;
(B-13) phenyltriethoxysilane; and
(B-14) phenyltripropoxysilane.

Cyclic Polysilane (Component G)

As described previously, the surface layer used in the present invention contains, besides the above high-molecular compound, a cyclic polysilane represented by the following general formula (7). That the surface layer contains this cyclic polysilane not only makes its surface have a low surface free energy at the initial stage, but also can keep the surface from being oxidized by ozone during running.

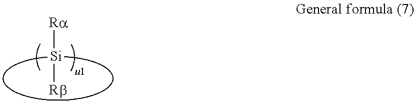

In the general formula (7), R_{α} and R_{β} each independently represent a hydrogen atom, a hydroxyl group, an alkyl group, an alkoxy group, an alkenyl group, a cycloalkyl group, a cycloalkyloxy group, a cycloalkenyl group, an aryl group, an aryloxy group or a silyl group.

From the viewpoint of water repellency, R_{α} and R_{β} may each preferably be a hydrocarbon group such as an alkyl group, an alkenyl group, a cycloalkyl group or an aryl group.

The alkyl group may preferably be, from the viewpoint of achievement of water repellency and compatibility with binders, a straight-chain or branched-chain alkyl group having 1 to 14 carbon atom(s), particularly preferably 1 to 10 carbon atom(s), and further preferably 1 to 6 carbon atom(s). As specific examples of the alkyl group, it may include a methyl group, an ethyl group, a propyl group, an isopropyl group, a butyl group, a t-butyl group and a pentyl group.

The alkoxy group may preferably be, from the viewpoint of achievement of water repellency, compatibility with binders and reactivity with the high-molecular compound, a straight-chain or branched-chain alkoxy group having 1 to 14 carbon atom(s), particularly preferably 1 to carbon atom(s), and further preferably 1 to 6 carbon atom(s). As specific examples of the alkoxy group, it may include a methoxyl group, an ethoxyl group, a propoxyl group, an isopropoxyl group, a butoxyl group, a t-butoxyl group and a pentyloxyl group.

The alkenyl group may preferably be, from the viewpoint of achievement of water repellency and compatibility with binders, an alkenyl group having 2 to 14 carbon atom(s), particularly preferably 2 to 10 carbon atom(s), and further preferably 2 to 6 carbon atom(s). As specific examples of the alkenyl group, it may include a vinyl group, an allyl group, a butenyl group and a pentenyl group.

The cycloalkyl group may preferably be, from the viewpoint of achievement of water repellency and compatibility with binders, a cycloalkyl group having 5 to carbon atom(s), and particularly preferably 5 to 10 carbon atom(s). As specific examples of the cycloalkyl group, it may include a cyclopentyl group, a cyclohexyl group and a methylcyclohexyl group.

The cycloalkyloxy group may preferably be, from the viewpoint of achievement of water repellency and compatibility with binders, a cycloalkyloxy group having 5 to 14 carbon atom(s), and particularly preferably 5 to 10 carbon atom(s). As specific examples of the cycloalkyloxy group, it may include a cyclopentyloxyl group and a cyclohexyloxyl group.

The cycloalkenyl group may preferably be, from the viewpoint of achievement of water repellency and compatibility with binders, a cycloalkenyl group having 5 to 14 carbon atom(s), and particularly preferably 5 to 10 carbon atom(s). As specific examples of the cycloalkenyl group, it may include a cyclopentenyl group and a cyclohexenyl group.

The aryl group may preferably be, from the viewpoint of achievement of water repellency and compatibility with binders, a substituted or unsubstituted phenyl group. As specific examples of the aryl group, it may include a phenyl group, a methylphenyl group (tolyl group), a dimethylphenyl group (xylyl group), a naphthyl group, a benzyl group, a phenethyl group and a phenylpropyl group.

The aryloxy group may preferably be, from the viewpoint of achievement of water repellency and compatibility with binders, an aryloxy group having 6 to 20 carbon atom(s), particularly preferably 6 to 15 carbon atom(s), and further preferably 6 to 12 carbon atom(s). As specific examples of the aryloxy group, it may include a phenoxyl group and a naphthyloxyl group.

From the viewpoint of water repellency and keeping the surface from being oxidized by ozone, the substituents represented by R_{α} and R_{β} may each particularly preferably be a phenyl group.

The u1 that means the number of members of the cyclic polysilane in the general formula (7) is an integer of 4 or more to 12 or less. Here, u1 may preferably be 5 or more from the viewpoint of compatibility with binders, and 10 or less from the viewpoint of solubility in solvents used, much preferably 8 or less, and further preferably 6 or less.

As the cyclic polysilane, what may be used is, e.g., OGSOL SI-30-10, trade name, available from Osaka Gas Chemicals Co., Ltd.; in which u1 is 5 and R_{α} and R_{β} are all phenyl groups.

The cyclic polysilane represented by the general formula (7) may preferably have a molecular weight of from 200 or more to 5,000 or less, much preferably from 400 or more to 3,000 or less, further preferably from 500 or more to 2,000 or less, and particularly preferably from 600 or more to 1,500 or less, as number-average molecular weight. Such a cyclic polysilane shows a tendency to be highly dispersible in and highly compatible with resins. Its ratio of weight-average molecular weight (Mw) to number-average molecular weight (Mn) may preferably be Mw/Mn=1 or more to 2 or less, and particularly preferably from 1.1 or more to 1.5 or less, from the viewpoint of the uniformity of dispersion in binders.

The cyclic polysilane in the surface layer may preferably be added in an amount (content) of from 1.0 part by mass or more to 10.0 parts by mass or less, based on 100 parts by mass of the high-molecular compound having the Si—O—Ti linkage in the molecular structure. As long as it is within this range, the surface can easily be kept from being oxidized by ozone during running, and any toner, external additive and so forth can easily be made to less adhere to the surface. The cyclic polysilane in the surface layer may also preferably be in a content of approximately from 3% by mass or more to 7% by mass or less, based on the total mass of the high-molecular compound in the surface layer. Incidentally, the content of the high-molecular compound and cyclic polysilane in the surface layer may be measured by pyrolysis GC/MS. It is also preferable for the surface layer to be so designed as not to contain any component other than the high-molecular compound and cyclic polysilane according to the present invention.

The present inventors have discovered that the addition of the cyclic polysilane to the high-molecular compound having the Si—O—Ti linkage brings out the effect of keeping the surface from being oxidized by ozone during running.

It is commonly known that oxygen radicals and ozone having been generated are so much highly active as to act directly on material surfaces to produce acidic groups (such as C═O, —OH and —COOH). In particular, from the viewpoint of bond energy, when these acidic groups are compared with C═C: 145 kcal/mol, Si—O: 106 kcal/mol, Si—O(Si—O₂): 150 kcal/mol, and Ti—O(Ti—O₂): 145 kcal/mol, they have bond energy that is as low as C—C: 84 kcal/mol, C—H: 98 kcal/mol, C—O: 76 kcal/mol and so forth, and hence can be said to stand readily dissociative.

That is, the R₃₃ and R₆₇ moieties represented in the general formula (12) and the general formula (18), respectively, can be presumed relatively susceptible to the oxidation by ozone.

Now, the surface layer according to the present invention has been analyzed by ESCA to find that, inasmuch as the ratio of Ti/Si in the high-molecular compound is 0.1 or more to 12.5 or less as described previously, the outermost surface of the surface layer has stood rich in Ti and low in Si—R (R is, e.g., R₃₃ or R₆₇). Such constitution can be said to be constitution preferable for the surface of the charging member to be kept from being oxidized when the electrophotographic photosensitive member is charged.

On the contrary thereto, in the case when the ratio of Ti/Si in the high-molecular compound is within the above range, there has been seen a tendency that the Si—R increases with a decrease in the layer thickness of the surface layer. This is disadvantageous in order for the surface of the charging member to be kept from being oxidized when the electrophotographic photosensitive member is charged. However, even in such a case, the incorporation of the cyclic polysilane according to the present invention into the surface layer can weaken the degree of segregation of Si—R to the outermost surface of the surface layer, so that a charging member having a superior oxidation resistance can be obtained.

Forming of Surface Layer

The surface layer used in the present invention may be obtained by the following method. That is, first, the first or second condensate is synthesized from the hydrolyzable compounds represented by the general formulas (12) and (13) or the hydrolyzable compounds represented by the general formulas (12), (13) and (18). Then, to the condensate obtained, the cyclic polysilane compound represented by the general formula (7) is added. Then, the epoxy groups in R₃₃ of this condensate are cleaved to effect cross-linking of this condensate to synthesize the high-molecular compound composed of the first or second cross-linked product. Thus, the surface layer containing the high-molecular compound and cyclic polysilane can be produced.

As an actual operation, a coating film of a coating material containing the above first or second condensate and cyclic polysilane compound is formed on the elastic layer and thereafter the first or second condensate is cross-linked, whereby the charging member of the present invention can be produced.

How to form the surface layer on the elastic layer to produce the charging member is specifically described below.

The surface layer used in the present invention, which contains the high-molecular compound composed of the second cross-linked product, may be produced through the following step (1) to step (7). In the following, a component (A) is the general formula (12) hydrolyzable silane compound, a component (B) is the general formula (18) hydrolyzable silane compound and a component (C) is the general formula (13) hydrolyzable titanium compound. Also, a component (G) is the general formula (7) cyclic polysilane compound.

(1): The step of adjusting the molar ratio of components (A), (B) and (C);

(2): the step of mixing the components (A) and (B), and then adding to the resultant mixture a component-(D) water and a component-(E) alcohol, and thereafter effecting hydrolysis and condensation;

(3): the step of adding the component (C) to a solution obtained by effecting the hydrolysis and condensation;

(4): the step of adding the component (G), having been dissolved in a cyclic polyether type solvent, to the solution obtained in the step (3);

(5): the step of adding a photopolymerization initiator to the solution obtained in the step (4), and thereafter controlling the solid-matter concentration of the resultant reaction solution to obtain a coating medium (coating material);

(6): the step of applying the coating medium onto the elastic layer formed on the substrate; and

(7): the step of subjecting the hydrolyzed condensate synthesized from the components (A), (B) and (C), to cross-linking reaction to cure the coating medium.

Step (1)

First, the molar ratio of the components (A), (B) and (C) are adjusted. On that occasion, their molar ratio, component (C)/[component (A)+component (B)], may be so adjusted as to be from 0.1 or more to 12.5 or less, and particularly preferably from 0.5 or more to 10.0 or less. This is preferable for the charging member according to the present invention to be much more improved in its charging performance. Inasmuch as this molar ratio is 12.5 or less, the coating material (coating medium) having been synthesized can easily be prevented from becoming milky and can easily be prevented from precipitating. Also, the molar ratio of the components (A) and (B), component (A)/[component (A)+component (B)], may preferably be 0.1 or more from the viewpoint of improvement in adherence to the conductive elastic layer, and may preferably be 0.9 or less in order to secure the stability of the liquid according to the step (2), i.e., not to make the liquid according to the step (2) become milky.

Step (2)

The components (A) and (B) are mixed. On that occasion, the component (C) may be added simultaneously with the components (A) and (B), and in this case the step (3) may be omitted. Also, the component (C) may be added two times dividedly into the steps (2) and (3). Still also, as the hydrolyzable silane compounds, one type of each of the components (A) and (B) may be used, and also two or more types of each of the components (A) and (B) may be used. Still also, without use of the component (B), one type or two or more types of the component (A) only may be used, whereby a surface layer containing a high-molecular compound composed of the first cross-linked product only can be produced through the steps (1) to (7).

Next, to the mixture obtained, the component-(D) water and the component-(E) alcohol are added to carry out hydrolysis and condensation reaction. The hydrolysis and condensation reaction may be carried out by heating and refluxing the mixture obtained. On that occasion, the component-(D) water may be added in such an amount (number of moles) that its molar ratio, component (D)/[component (A)+component (B)], is from 0.3 or more to 6.0 or less. Inasmuch as it is within this range, appropriate condensation reaction may readily be carried out, and hence a stable coating material can readily be obtained in which any unreacted monomers can not easily remain and the properties of which can not easily change with time. This molar ratio may further preferably be from 1.2 or more to 3.0 or less.

As the component-(E) alcohol, from the viewpoints of the stability (retention of a uniform state) of a liquid during the reaction (hydrolysis and condensation) of the components (A), (B) and (C) and also the stability of the liquid during its storage, it is preferable to use a primary alcohol, a secondary alcohol, a tertiary alcohol, a mixed system of a primary alcohol and a secondary alcohol, or a mixed system of a primary alcohol and a tertiary alcohol. In particular, ethanol, a mixed solvent of methanol and 2-butanol or a mixed solvent of ethanol and 2-butanol is preferable from the viewpoint of the stability during storage. Here, the component-(E) alcohol may be added in such an amount that, during synthesis, the condensate may be in a concentration of 10% by mass or more, from the viewpoint of the stability during the synthesis.

Steps (3) and (4)

To and into the solution obtained through the step (2), the component (C) is added and mixed. This can make the hydrolysis condensation reaction with the component (C) proceed to obtain the second condensate composed of the components (A), (B) and (C). Thereafter, the component (G), having been dissolved in a cyclic ether type solvent, is added to the solution obtained. On that occasion, the component (G) in the cyclic ether type solvent may preferably be in a concentration of from 1% by mass to 10% by mass.

As this cyclic ether type solvent, tetrahydrofuran may be used, for example. Here, from the viewpoint of keeping the surface of the charging member from being oxidized by ozone, the component (G) may preferably be added in an amount of 1.0 part by mass or more, based on 100 parts by mass of the high-molecular compound having the Si—O—Ti linkage in the molecular structure, and, from the viewpoint of the stability and solubility of the liquid, in an amount of 10.0 parts by mass or less.

Step (5)

To the solution obtained through the step (4), the photopolymerization initiator is added. As the photopolymerization initiator, an onium salt of Lewis acid or Brφnsted acid is preferred. As other cationic polymerization catalyst, it may include, e.g., borates, compounds having an imide structure, compounds having a triazine structure, azo compounds and peroxides. The photopolymerization initiator may preferably beforehand be diluted with a solvent such as an alcohol (such as methanol) or a ketone (such as methyl isobutyl ketone) so as to be improved in compatibility with the coating medium.

Among such various cationic polymerization catalysts, an aromatic sulfonium salt or an aromatic iodonium salt is preferable from the viewpoint of sensitivity, stability and reactivity. In particular, a bis(4-tert-butylphenyl) iodonium salt, a compound having a structure represented by the following chemical formula (19) (trade name: ADECAOPTOMER SP150; available from Asahi Denka Kogyo K.K.) and a compound having a structure represented by the following chemical formula (20) (trade name: IRGACURE 261; available from Ciba Specialty Chemicals Inc.) are preferred.

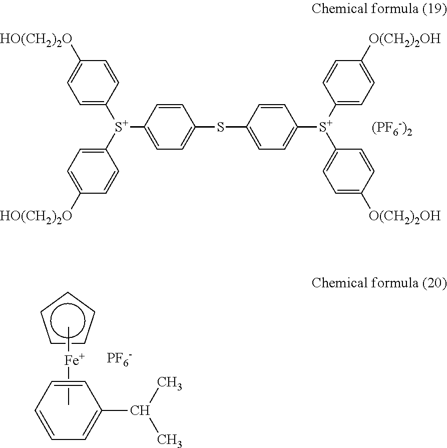

Subsequently, the solid-matter concentration of the resultant reaction solution is controlled to obtain the coating medium. Here, where the solid-matter concentration of the reaction solution to which the photopolymerization initiator has been added is a concentration suited for the coating on the elastic layer, the step (6) may be carried out as it is, without controlling the concentration. Specific examples of a solvent usable in controlling the concentration of the reaction solution are given below: Alcohols as exemplified by ethanol, methanol and 2-butanol; and ketones as exemplified by ethyl acetate, methyl ethyl ketone and methyl isobutyl ketone.

Any of the above alcohols and ketones may be used in the form of a mixture. In particular, from the viewpoint of the solubility of the initiator in alcohols, ethanol or a mixed solvent of methanol and 2-butanol or a mixed solvent of ethanol and 2-butanol is preferred.

The coating medium may preferably have a solid-matter concentration of from 0.05% by mass or more to 4.00% by mass or less, from the viewpoint of maintaining stable charging performance of the charging member and keeping any coating non-uniformity from occurring.

Steps (6) and (7); Formation of Surface Layer

The coating medium having been prepared in this way is coated on the conductive elastic layer by coating making use of a roll coater, dip coating, ring coating or the like to form a layer of the coating medium (hereinafter “coating layer”). Next, the coating layer is irradiated with activated-energy rays, whereupon cationic-polymerizable groups in the hydrolyzed condensate contained in the coating layer undergo cleavage and polymerization. This causes molecules of the hydrolyzed condensate to cross-link with one another to come cured, thus the surface layer is formed. As the activated-energy rays, ultraviolet rays are preferred.

The curing of the surface layer with ultraviolet rays makes any excess heat not easily generated, and any phase separation that may come during volatilization of a solvent as in heat curing can not easily occur or the surface layer can not easily come to wrinkle, thus a very uniform state of film is obtained. This enables the photosensitive member to be provided with uniform and stable potential.

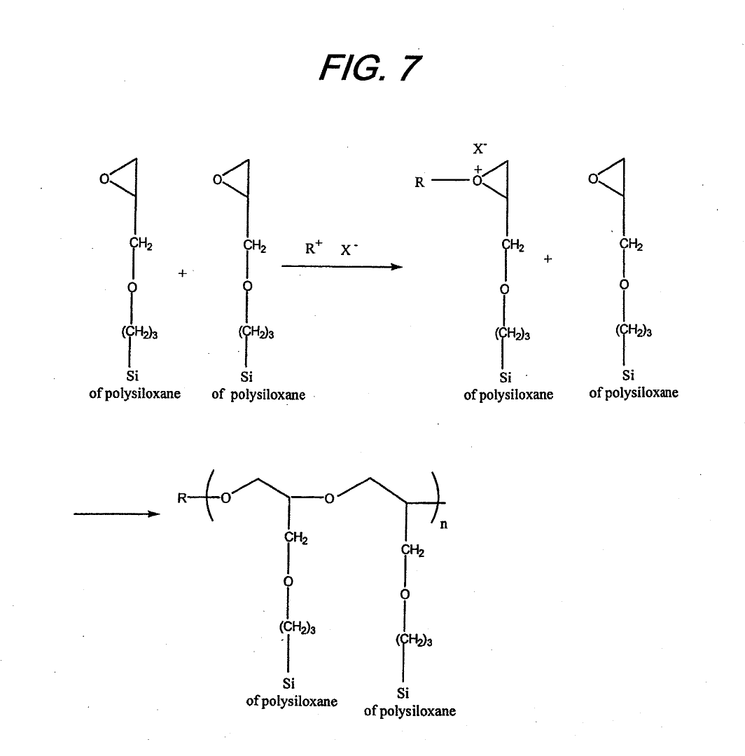

A specific example of the cross-linking and curing reaction with one another of the molecules of the hydrolyzed condensate is shown in FIG. 7. In FIG. 7, a condensate is presented which is formed by using 3-glycidoxypropyltrimethoxysilane or 3-glycidoxypropyltriethoxysilane as the component (A) described previously and also hydrolyzing the components (B) and (C). This condensate has glycidoxypropyl groups as cationic-polymerizable groups. The glycidoxypropyl groups of such a hydrolyzed condensate undergo ring-opening of epoxy rings in the presence of a cationic polymerization catalyst (represented as R⁺X⁻ in FIG. 7), and the polymerization proceeds chain-reactingly. As the result, molecules of a polysiloxane (condensate) containing TiO_{4/2} and SiO_{3/2} cross-link with one another to come cured, thus the surface layer is formed. In FIG. 7, n represents an integer of 1 or more.

Where the environment in which the charging member is placed is an environment causative of abrupt changes in temperature and humidity, the surface layer may come to wrinkle or crack if the surface layer does not well follow up the expansion and contraction of the conductive elastic layer which have been caused by such changes in temperature and humidity. However, as long as the cross-linking reaction is carried out by ultraviolet radiation, which less generates heat, the adherence between the conductive elastic layer and the surface layer is improved to enable the surface layer to well follow up the expansion and contraction of the conductive elastic layer. Hence, the surface layer can be kept from coming to wrinkle or crack because of the changes in temperature and humidity. In addition, as long as the cross-linking reaction is carried out by ultraviolet radiation, the conductive elastic layer can be kept from deterioration due to heat history, and hence the conductive elastic layer can also be kept from lowering in its electrical properties.

In the irradiation with ultraviolet rays, usable are a high-pressure mercury lamp, a metal halide lamp, a low-pressure mercury lamp, an excimer UV lamp and the like. Of these, an ultraviolet radiation source may be used which is rich in light of from 150 nm or more to 480 nm or less in wavelength of ultraviolet rays. Here, the integral light quantity of ultraviolet radiation is defined as shown below. Ultraviolet radiation integral light quantity (mJ/cm²)=ultraviolet radiation intensity (mW/cm²)×irradiation time (s).

The integral light quantity of ultraviolet radiation may be controlled by selecting irradiation time, lamp output, and distance between the lamp and the irradiation object. The integral light quantity may also be sloped within the irradiation time.

Where the low-pressure mercury lamp is used, the integral light quantity of ultraviolet radiation may be measured with an ultraviolet radiation integral light quantity meter UIT-150-A or UVD-S254 (both are trade names), manufactured by Ushio Inc. Where the excimer UV lamp is used, the integral light quantity of the ultraviolet rays may also be measured with an ultraviolet radiation integral light quantity meter UIT-150-A or VUV-S172 (both are trade names), manufactured by Ushio Inc.

The surface layer may have a thickness of approximately from 10 nm or more to 2,500 nm or less.

Image-Forming Apparatus & Process Cartridge

The charging member of the present invention may be used in an electrophotographic apparatus (image-forming apparatus) having an electrophotographic photosensitive member, and may also be used in a process cartridge which is so set up as to be detachably mountable to the main body of an electrophotographic apparatus.

How the image-forming apparatus and process cartridge in which the charging member of the present invention is used as a charging roller are set up is schematically described with reference to FIG. 2. Reference numeral 21 denotes a rotating drum-type electrophotographic photosensitive member (photosensitive member). This photosensitive member 21 is rotatingly driven clockwise as shown by an arrow in the drawing and at a stated peripheral speed (process speed). As the photosensitive member 21, any known photosensitive member may be employed which, e.g., has at least a roll-shaped conductive substrate and provided on the substrate a photosensitive layer containing an inorganic photosensitive material or organic photosensitive material. Also, the photosensitive member 21 may further have a charge injection layer for charging the photosensitive member surface to stated polarity and potential.

A charging means is constituted of a charging roller and a charging bias applying power source S2, which applies a charging bias to the charging roller 22. The charging roller 22 is kept in contact with the photosensitive member at a stated pressing force and, in this apparatus, rotatingly driven in the direction that follows the rotation of the photosensitive member 21. To the charging roller 22, a stated direct-current voltage (−1,050 V in Examples given later) is applied from the charging bias applying power source S2 (a DC charging system), whereby the surface of the photosensitive member is uniformly charge-processed to stated polarity and potential (to a dark-area potential of −500 V in Examples given later).

As an exposure means 23, any known means may be used, which may preferably be exemplified by a laser beam scanner or the like. Letter symbol L denotes exposure light. By the exposure means 23, the charge-processed surface of the photosensitive member 21 is put to imagewise exposure corresponding to the intended image information, whereupon the potential (light-area potential of −100 V in Examples given later) at exposed light areas on the charge-processed surface of the photosensitive member lowers (attenuates) selectively, so that electrostatic latent images are formed on the photosensitive member 21.

As a reverse developing means, any known means may be used. For example, in what is shown in FIG. 2, a developing means 24 has a toner carrying member 24a which is provided at an opening of a developer container holding a toner therein and carries and transports the toner, an agitating member 24b which agitates the toner held in the container, and a toner coat control member 24c which controls toner carrying level (toner layer thickness) on the toner carrying member. The developing means 24 makes the toner (negatively chargeable toner) adhere selectively to the exposed light areas of the electrostatic latent images on the surface of the photosensitive member 21 to render the electrostatic latent images visible as toner images; the toner standing charged (at a development bias of −400 V in Examples given later) to the same polarity as that of charge polarity of the photosensitive member 21. As a developing system therefor, any known jumping developing system, contact developing system, magnetic-brush developing system or the like may be used. Then, in an image-forming apparatus which reproduces color toner images, it is preferable to use the contact developing system, which can remedy the disposition of toner scattering.

As a transfer roller 25, a transfer roller comprising a conductive substrate made of a metal or the like and covered thereon with an elastic resin layer having been controlled to have a medium resistance. The transfer roller 25 is kept in contact with the photosensitive member 21 under a stated pressing force, and is rotated in the direction following the rotation of the photosensitive member 21 at a peripheral speed substantially equal to the rotational peripheral speed of the photosensitive member 21. A transfer voltage having a polarity reverse to the charge characteristics of the toner is also applied from a transfer bias applying power source S4.

A transfer material P is fed at a stated timing through a paper feed mechanism (not shown) to the part of contact between the photosensitive member 21 and the transfer roller, and the transfer material P is charged on its back, to a polarity reverse to the charge polarity of the toner by means of the transfer roller 25, to which a transfer voltage is kept applied. Thus, the toner images on the surface side of the photosensitive member 21 are electrostatically transferred to the surface side of the transfer material P at the part of contact between the photosensitive member 21 and the transfer roller.

The transfer material P to which the toner images have been transferred is separated from the surface of the photosensitive member, and is guided into a toner image fixing means (not shown), where the toner images are fixed, and then the image-fixed transfer material is put out as an image-formed matter. In the case of a double-side image-forming mode or a multiple-image-forming mode, this image-formed matter is guided into a recirculation delivery mechanism (not shown) and is again guided to the transfer zone.

Residual matter such as transfer residual toner on the photosensitive member 21 is collected from the surface of the photosensitive member by a cleaning means 26 of a blade type or the like.

The process cartridge of the present invention integrally supports the photosensitive member 21 and the charging member 22, which is according to the present invention, disposed in contact with the photosensitive member 21, and is so set up as to be detachably mountable to the main body of the electrophotographic apparatus.

### EXAMPLES

The present invention is described below in greater detail by giving specific working examples. In the following working examples, “part(s)” refers to “part(s) by mass”.

### Example 1

### (1) Formation & Evaluation of Conductive Elastic Layer

TABLE 1

| | Amount |
|---|---|
| | [part(s) |
| Raw materials | by mass] |
| Medium/high-nitrile NBR (trade name: NIPOL | 100 |
| DN219; available from Nippon Zeon Co., Ltd.) | |
| Bound acrylonitrile content center value: | |
| 33.5%; Mooney viscosity center value: 27 | |
| Carbon black for color (filler) (trade name: | 48 |
| #7360SB; available from Tokai Carbon Co., | |
| Ltd.) | |
| Particle diameter: 28 nm; nitrogen | |
| adsorption specific surface area: 77 m²/g; | |
| DBP oil absorption: 87 cm³/100 g | |
| Calcium carbonate (filler) (trade name: | 20 |
| NANOX #30; available from Maruo Calcium Co., | |
| Ltd.) | |
| Zinc oxide | 5 |
| Stearic acid | 1 |

Materials shown in Table 1 were mixed by means of a 6-liter volume pressure kneader (trade name: TD6-15MDX; manufactured by Toshin Co., Ltd.) for 24 minutes in a packing of 70 vol. % and at a number of blade revolutions of rpm to obtain an unvulcanized rubber composition. To 174 parts by mass of this unvulcanized rubber composition, 4.5 parts of tetrabenzylthiuram disulfide (trade name: SANCELER TBzTD; available from Sanshin Chemical Industry Co., Ltd.) as a vulcanization accelerator and 1.2 parts of sulfur as a vulcanizing agent were added. Then, these were mixed by means of an open roll of 30.5 cm (12 inches) in roll diameter at a number of front-roll revolutions of 8 rpm and a number of back-roll revolutions of 10 rpm and at a roll gap of 2 mm, carrying out right and left 20 cuts in total. Thereafter, the roll gap was changed to 0.5 mm to carry out tailing 10 times to obtain a kneaded product I for conductive elastic layer.

Next, a substrate made of steel (one having been surface-plated with nickel) in a columnar shape of 6 mm in diameter and 252 mm in length was readied. Then, this substrate was coated with a metal- and rubber-containing heat-hardening adhesive (trade name: METALOC U-20, available from Toyokagaku Kenkyusho Co., Ltd.) over regions up to 115.5 mm from the both sides interposing the middle of the column surface in the axial direction (regions of 231 mm in total in width in the axial direction). The wet coating thus formed was dried at 80° C. for 30 minutes, and thereafter further dried at 120° C. for 1 hour to obtain a substrate with adhesive layer.

Next, the kneaded product I was extruded coaxially on the above substrate with adhesive layer in the shape of a cylinder of 8.75 mm to 8.90 mm in diameter, by extrusion making use of a cross head. The extruded product obtained was cut at its end portions to produce a conductive elastic roller the substrate of which was covered on the outer periphery thereof with an unvulcanized conductive elastic layer. As an extruder, an extruder having a cylinder diameter of 70 mm [d (diameter) 70] and an L/D of 20 was used, making temperature control to 80° C. for its head, 100° C. for its cylinder and 100° C. for its screw at the time of extrusion.

Next, this conductive elastic roller was vulcanized by using a continuous heating oven having two zones set at different temperatures. A first zone was set at a temperature of 80° C., where the roller was passed therethrough in 30 minutes, and a second zone was set at a temperature of 160° C., where the roller was passed therethrough also in 30 minutes, to obtain a vulcanized conductive elastic roller.

Next, this vulcanized conductive elastic roller was cut at its both ends of the conductive elastic layer portion (rubber portion) to make the conductive elastic layer portion have a width of 232 mm in the axial direction. Thereafter, the surface of the conductive elastic layer portion was sanded with a rotary grinding wheel (number of work revolutions: 333 rpm; number of grinding wheel revolutions: 2,080 rpm; sanding time: 12 seconds). Thus, a conductive elastic roller 1 was obtained which had a crown shape of 8.26 mm in diameter at end portions and 8.50 mm in diameter at the middle portion, having a surface ten-point average roughness (Rz) of 5.5 μm, having a run-out of 18 μm and having an MD-1 hardness of 73 degrees.

The ten-point average roughness (Rz) was measured according to JIS B 0601 (1994). The run-out was measured with a high-precision laser measuring instrument (trade name: LSM-430V, manufactured by Mitutoyo Corporation). Stated in detail, the outer diameter was measured with this measuring instrument, and the difference between a maximum outer diameter value and a minimum outer diameter value was regarded as outer-diameter difference run-out. This measurement was made at five spots, and an average value of outer-diameter difference run-out at five spots was regarded as the run-out of the measuring object.

The MD-1 hardness was measured with MD-1 capa (trade name; manufactured by Kobunshi Keiki Co., Ltd.) in a measurement environment of 25° C./55% RH (relative humidity). Type C was used as an indenter point.

(2) Synthesis of Condensate

Next, a condensate 1 used to produce the high-molecular compound was synthesized.

Synthesis of Condensate Intermediate 1

First, components shown in Table 2 below were mixed, and thereafter stirred at room temperature for 30 minutes.

TABLE 2

| Raw materials | Amount | |
|---|---|---|
| Glycidoxypropyltrimethoxysilane (GPTMS, | 11.56 | g |
| hereinafter simply “EP-1”) | (0.049 | mol) |
| (hydrolyzable silane compound; trade | | |
| name: KBM-403; available from Shin-Etsu | | |
| Chemical Co., Ltd.) | | |
| Hexyltrimethoxysilane (HeTMS, hereinafter | 11.56 | g |
| simply “He”) | (0.049 | mol) |
| (hydrolyzable silane compound; trade | | |
| name: KBM-3063; available from Shin-Etsu | | |
| Chemical Co., Ltd.) | | |
| Ion-exchanged water | 11.34 | g |
| Ethanol (guaranteed; available from | 91.87 | g |
| Kishida Chemical Co., Ltd.) | | |

Subsequently, heating and reflux were carried out at 120° C. for 20 hours by using an oil bath, to allow the mixed components to react to obtain a condensate intermediate 1. This condensate intermediate 1 was 28.0% by mass as theoretical solid content (the mass ratio to solution total mass of a polysiloxane polymeric product when the hydrolyzable silane compounds were assumed to have undergone dehydration condensation in their entirety). Also, the molar ratio of the ion-exchanged water to the hydrolyzable silane compounds at this stage, (D)/[(A)+(B)], was 1.8.

Synthesis of Condensate 1

Next, to 167.39 g of the condensate intermediate 1, cooled to room temperature, 9.41 g (0.331 mol) of titanium i-propoxide (hereinafter “Ti-1”) (hydrolyzable titanium compound; available from Kojundo Chemical Laboratory Co., Ltd.) was added, and these were stirred at room temperature for 3 hours to obtain a condensate 1. A sequence of stirring was carried out at 750 rpm. Also, the value of Ti/Si was 0.10.

Meanwhile, a cyclic polysilane (trade name: OGSOL SI-30-10; available from Osaka Gas Chemicals Co., Ltd.) was so dissolved in a cyclic ether solvent tetrahydrofuran (THF) as to be 10% by mass in solid content. The solution obtained was so added to the condensate 1 that the cyclic polysilane came to be 0.5 part by mass based on 100 parts by mass of the condensate. Further, to the mixture obtained, 0.7 g of a solution was added which was prepared by diluting an aromatic sulfonium salt (trade name: ADECAOPTOMER SP150; available from Asahi Denka Kogyo K.K.) as a cationic photopolymerization initiator with methanol to 10% by mass. The resultant mixture is called a “mixture of condensate 1, cyclic polysilane and photopolymerization initiator”.

Evaluation (1): Identification of chemical structure in cured product of mixture of condensate 1 and cyclic polysilane.

The chemical structure of a mixture of condensate 1 and cyclic polysilane was confirmed by ²⁹Si-NMR and ¹³C-NMR measurement (instrument used: JMN-EX400, trade name; manufactured by JEOL Ltd.). How to prepare a sample for the measurement is described below.

First, to the “mixture 1 of condensate 1, cyclic polysilane and photopolymerization initiator”, a 1:1 (mass ratio) mixed solvent of ethanol and 2-butanol was added to regulate the “mixture 1 of condensate 1, cyclic polysilane and photopolymerization initiator” to have a solid-matter concentration of 3.0% by mass, to obtain a “coating solution 1”.

Next, this “coating solution 1” was spin-coated on the surface of a sheet made of aluminum, having a thickness of 100 μm and having been surface-degreased, by using a spin coating equipment (trade name: 1H-D7; manufactured by Mikasa Co., Ltd.). The spin coating was carried out under conditions of a number of revolutions of 300 rpm and a revolution time of 2 seconds.

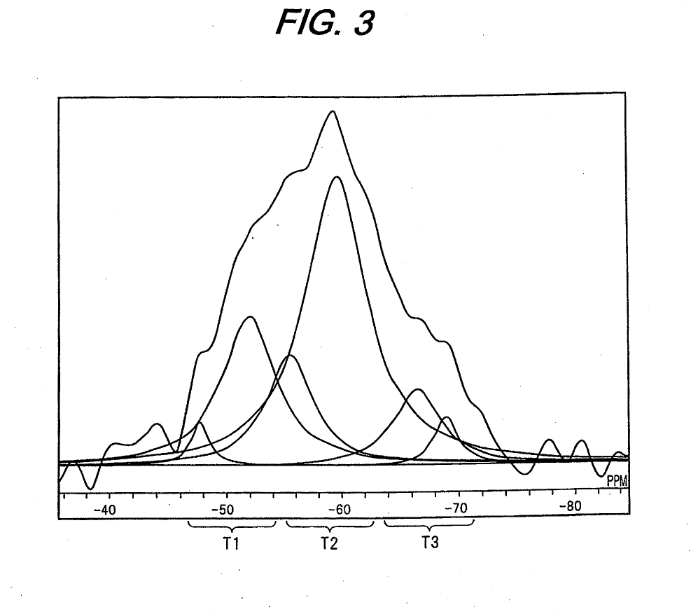

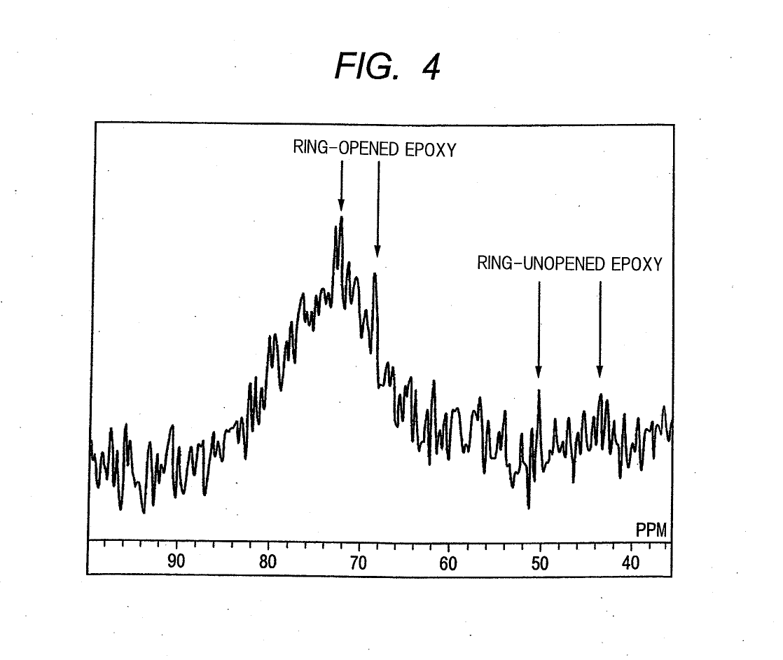

Then, the wet coating of the “coating solution 1” was dried, and thereafter the coating film formed was irradiated with ultraviolet rays of 240 nm in wavelength to cure the coating film. The ultraviolet rays with which the coating film was irradiated were in an integral light quantity of 9,000 mJ/cm². In the irradiation with ultraviolet rays, a low-pressure mercury lamp (manufactured by Harison Toshiba Lighting Corporation) was used. Next, the cured film formed was peeled from the sheet made of aluminum, and then pulverized by using a mortar made of agate, to prepare the sample for NMR measurement. This sample was measured for its ²⁹Si-NMR and ¹³C-NMR by using a nuclear magnetic resonance instrument (trade name; JMN-EX400, manufactured by JEOL Ltd.). The results of measurement are shown in FIGS. 3 and 4.

A region T1 shown in the results of ²⁹Si-NMR measurement in FIG. 3 shows —SiO_{1/2}(OR)₂, a region T2 shows —SiO_{2/2}(OR) and a region T3 shows —SiO_{3/2}. From the fact that peaks are present in the region T3, it was ascertainable that there was a species present in the state of —SiO_{3/2} upon condensation of a hydrolyzable silane compound having organic chains containing epoxy groups. It was confirmed from ¹³C-NMR shown in FIG. 4 that the polymerization was effected almost without any epoxy groups remaining unopened.

From the foregoing, it was ascertainable that the cured product of the condensate 1, i.e., the high-molecular compound had the structure represented by the general formula (1).

(3) Production & Evaluation of Charging Rollers 1-1 to 1-3

Preparation of Surface Layer Forming Coating Materials

To the “mixture 1 of condensate 1, cyclic polysilane and photopolymerization initiator”, a 1:1 (mass ratio) mixed solvent of ethanol and 2-butanol was added to regulate the former to have a solid-matter concentration of 1.0% by mass, 10% by mass and 25% by mass each, to obtain surface layer forming coating materials. These are designated as surface layer forming coating materials 1-1 to 1-3, respectively.

Evaluation (2): Evaluation of stability of surface layer forming coating materials.

The above surface layer forming coating materials 1-1 to 1-3 were each put into a transparent container and left to stand, and whether or not these became milky was visually continuously observed to make evaluation according to the criteria shown in Table 3 below.

TABLE 3

| Rank | Evaluation criteria |
|---|---|
| A | The coating material neither stands milky nor |
| | has precipitated even after 1 month has passed. |
| B | The coating material stands a little milky |
| | after about 2 weeks have passed. |
| C | The coating material stands a little milky |
| | after about 1 week has passed. |
| D | The coating material has already stood milky |
| | and has precipitated at the time of synthesis. |

Formation of Surface Layer

About the conductive elastic roller 1 produced in the above (1), three rollers were readied and these conductive elastic rollers 1 were respectively coated, on their peripheral surfaces of the conductive elastic layers, with the surface layer forming coating materials 1-1 to 1-3 by ring coating to form coating films of the respective coating materials. Then, the coating films thus formed were each irradiated with ultraviolet rays of 254 nm in wavelength in such a way as to be in an integral light quantity of 9,000 mJ/cm² to effect curing to form surface layers. In the irradiation with ultraviolet rays, a low-pressure mercury lamp (manufactured by Harison Toshiba Lighting Corporation) was used. Thus, charging rollers Nos. 1-1 to 1-3 were produced.

Subsequently, the following evaluations (3) to (7) were made.

Evaluation (3): Evaluation of charging roller. How the external appearance of the surface of each charging roller stands was evaluated by visual observation and according to the criteria shown in Table 4 below.

TABLE 4

| Rank | Evaluation criteria |
|---|---|
| A | Any faulty coating is not seen at all on the |
| | surface of the charging roller. |
| B | Faulty coating has appeared on some part (non |
| | image area) of the surface of the charging |
| | roller. |
| C | Faulty coating has appeared on the whole area |
| | of the surface of the charging roller. |

Evaluation (4): Measurement of thickness of surface layer.

The thickness of a section of the surface layer of each charging roller was measured with a scanning transmission electron microscope (trade name: HD-2000; manufactured by Hitachi High-Technologies Corporation).

Evaluation (5): Identification of TiO_{4/2} and Si—O—Ti linkage.

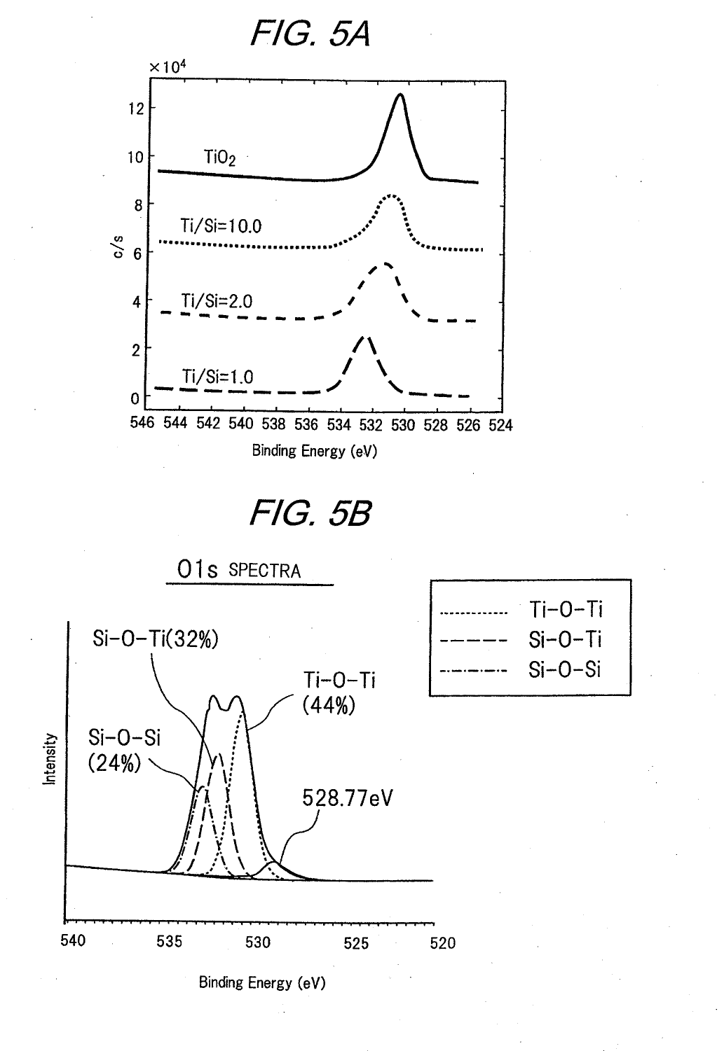

The presence of TiO_{4/2} and Si—O—Ti linkage in the surface layer of each charging roller was identified by using ESCA (instrument used: QUANTUM 2000, trade name; manufactured by Ulvac-Phi, Inc.). The charging roller surface was so made as to be irradiated with X-rays to evaluate the manner of linkage in the surface layer. The results of measurement are shown in FIGS. 5A and 5B. From O1s spectra detected, the presence of TiO_{4/2} and Si—O—Ti linkage was identified.

Evaluation (6): Evaluation on contamination of photosensitive member.

The charging rollers were each set in a process cartridge (trade name: CRG-318BLK; manufactured by CANON INC.) used for a laser beam printer (trade name: LBP 7200C; manufactured by CANON INC.), and then left to stand for a month in a high-temperature and high-humidity environment (temperature: 40° C., relative humidity: 95%) while keeping the state that each charging roller and the photosensitive member came into contact with each other.

On an optical microscope, the photosensitive member (drum) was observed at its part of contact with the charging roller, and whether or not any difficulty (cracking, change in color) occurred because the charging roller was in contact thereat was observed to make evaluation according to the criteria shown in Table 5 below.

TABLE 5

| Rank | Evaluation criteria |
|---|---|
| A | No change is seen on the drum surface. |
| B | No problem on images, but deposits are slightly |
| | seen on the drum surface. |
| C | No problem on images, but many deposits are |
| | seen on the drum surface. |
| D | cracks are seen on the drum surface. |

Evaluation (7): Changes in surface free energy of charging roller surface with use.

A laser beam printer (trade name: LBP 6200C, A4 25 sheets/minute; manufactured by CANON INC.) was readied. This laser beam printer can reproduce images on 24 sheets of A4-size paper per minute in the lengthwise direction.

Then, the charging roller to be evaluated were each set in a process cartridge (trade name: CRG-326; manufactured by CANON INC.) used for the above laser beam printer. This process cartridge was mounted to the laser beam printer, and electrophotographic images were reproduced on 2,000 sheets in a low-temperature and low-humidity environment (temperature: 15° C., relative humidity: 10%). Here, the electrophotographic images were images where horizontal lines of 2 dots in width were drawn at intervals giving 112 spaces in the direction perpendicular to the rotational direction of the electrophotographic photosensitive member. Also, the above electrophotographic images were reproduced in what is called an intermittent mode, in which the rotation of the electrophotographic photosensitive member was stopped over a period of 10 seconds at intervals of reproduction on two sheets. The image reproduction in such an intermittent mode comes to a larger number of times of friction between the charging roller and the electrophotographic photosensitive member than a case in which electrophotographic images are continuously formed, and hence this provides severer evaluation conditions for the charging roller.

After the electrophotographic images were reproduced on 2,000 sheets, the charging roller was detached from the process cartridge, and the surface of this charging roller was washed with water. Then, about the charging roller's surface having been washed, its contact angles θ to three sorts of probe liquids as shown in Table 6 below were measured with a contact angle meter (trade name: CA-X ROLL Model, manufactured by Kyowa Interface Science Co., Ltd.). The contact angles were measured under conditions shown in Table 7 below. In the following, L and S represent corresponding items of a liquid and a solid, respectively.

γ^{d}: Dispersion force term.
γ^{P}: Polar term.
γ^{h}: Hydrogen bond term.

TABLE 6

Values at 20° C. of three components
of surface free energy
(mJ/m²)

| Probe liquids | γL^{d} | γL^{p} | γL^{h} | γL^{Total} |
|---|---|---|---|---|
| Water | 29.1 | 1.3 | 42.4 | 72.8 |
| Diiodomethane | 46.8 | 4 | 0 | 50.8 |
| Ethylene glycol | 30.1 | 0 | 17.6 | 47.7 |

TABLE 7

| | |
|---|---|
| Measurement: | Droplet method (true- |
| | circle fitting). |
| Quantity of liquid: | 1 μl. |
| Droplet impact recognition: | Automatic. |
| Image processing: | Algorithm-nonreflection. |
| Image mode: | Frame. |
| Threshold level: | Automatic. |

In the above Table 6, γL^{d}, γL^{p} and γL^{h} represent the dispersion force term, the polar term and the hydrogen bond term, respectively. The respective terms (γL^{d}, γL^{p}, γL^{h}) of the three sorts of probe liquids in the above Table 6 and the contact angles θ to the respective probe liquids that were found by the measurement were substituted for those of the following Kitazaki-Hata theory [calculation expression (1)] to prepare three equations about the respective probe liquids, and their simultaneous cubic equations were solved to thereby calculate the values of γS^{d}, γS^{p} and γS^{h}. Then, the sum of the values of γS^{d}, γS^{p} and γS^{h} was taken as the surface free energy (γ^{Total})

$$\sqrt{{γ}_{L}^{d} \times {γ}_{S}^{d}} + \sqrt{{γ}_{L}^{p} \times {γ}_{S}^{p}} + \sqrt{{γ}_{L}^{h} \times {γ}_{S}^{h}} = \frac{{γ}_{L} ( 1 + cos θ )}{2} \qquad Calculation expression ( 1 )$$

Here, as an index of the degree of oxidation by ozone, the sum of the γₚ (polar term) and γ^{h} (hydrogen bond term) was used. With respect to the value of [γₚ (before)+γ^{h} (before)]/γ^{Total} (before)]×100 that was found by the measurement of surface free energy of the charging member before the running test, the value of [γ^{p} (after)+γ^{h} (after)]/γ^{Total} (after)]×100 that was found by the measurement of surface free energy of the charging member after the running test and after washing with water was used, and the difference (Δ) between them was taken as the degree of oxidation by ozone to make evaluation according to the criteria shown in Table 8 below.

TABLE 8

| Rank | Criteria |
|---|---|
| A | 0 ≦ Δ ≦ 2 |
| B | 2 < Δ ≦ 4 |
| C | 4 < Δ ≦ 6 |
| D | 6 < Δ ≦ 10 |
| E | 10 < Δ |

### Examples 2 to 23

### (1) Preparation & Evaluation of Condensates Nos. 2 to 23

Condensate intermediates 2 to 7 were prepared in the same way as the condensate intermediate 1 in Example 1 except that they were composed as shown in Table 9 below. Next, condensates 2 to 23 were prepared in the same way as the condensate 1 in Example 1 except that they were composed as shown in Table 10 below. Evaluation was made in the same way as the method described in Evaluation (1) in Example 1 except that the respective condensates obtained were used. Results obtained are shown in Table 12.

TABLE 9

| | Synthesis 1 | | | | | |
|---|---|---|---|---|---|---|
| Condensate | Component (A) | | | | Component (B) | |
| intermediate | EP-1 | EP-2 | EP-3 | EP-4 | He | Ph |
| No. | (g) | (g) | (g) | (g) | (g) | (g) |
| 1 | 11.56 | — | — | — | 62.11 | — |
| 2 | 38.35 | — | — | — | 33.53 | — |
| 3 | 61.70 | — | — | — | 8.78 | — |
| 4 | 12.22 | — | — | — | 15.27 | 56.92 |
| 5 | — | 9.84 | — | — | 64.95 | — |
| 6 | — | — | 14.98 | — | 59.63 | — |
| 7 | — | — | — | 11.93 | 61.40 | — |

Here, abbreviation symbols EP-1 to EP-5, He and Ph in the columns of the components (A) and (B) in Table 9 and also an abbreviation symbol Ti-1 to Ti-3 in the column of the component (C) in Table 10 represent the compounds shown in Table 11.

TABLE 10

| | Condensate | | | | | |
|---|---|---|---|---|---|---|
| | intermediate | | Component (C) | | | |
| Condensate | | Amount | Ti-1 | Ti-2 | Ti-1 | |
| No. | No. | (g) | (g) | (g) | (g) | Ti/Si |
| 1 | 1 | 167.39 | 9.41 | — | — | 0.10 |
| 2 | 1 | 40.41 | 136.39 | — | — | 6.00 |
| 3 | 1 | 22.02 | 154.78 | — | — | 12.50 |
| 4 | 1 | 167.39 | 9.41 | — | — | 0.10 |
| 5 | 1 | 40.41 | 136.39 | — | — | 6.00 |
| 6 | 1 | 26.69 | 150.11 | — | — | 10.00 |
| 7 | 1 | 167.39 | 9.41 | — | — | 0.10 |
| 8 | 1 | 40.41 | 136.39 | — | — | 6.00 |
| 9 | 1 | 22.02 | 154.78 | — | — | 12.50 |
| 10 | 1 | 171.96 | 4.84 | — | — | 0.05 |
| 11 | 1 | 40.41 | 136.39 | — | — | 6.00 |
| 12 | 1 | 22.02 | 154.78 | — | — | 12.50 |
| 13 | 1 | 167.39 | 9.41 | — | — | 0.10 |
| 14 | 1 | 40.41 | 136.39 | — | — | 6.00 |
| 15 | 1 | 26.69 | 150.11 | — | — | 10.00 |
| 16 | 2 | 42.73 | 134.07 | — | — | 6.00 |
| 17 | 3 | 44.96 | 131.84 | — | — | 6.00 |
| 18 | 4 | 79.83 | 96.97 | — | — | 6.00 |
| 19 | 5 | 39.04 | 137.76 | — | — | 6.00 |
| 20 | 6 | 41.65 | 137.76 | — | — | 6.00 |
| 21 | 7 | 40.73 | 136.07 | — | — | 6.00 |
| 22 | 1 | 58.11 | — | 118.69 | — | 6.00 |
| 23 | 1 | 21.12 | — | — | 155.68 | 6.00 |

TABLE 11

| Sym. | Name | Structure | Maker |
|---|---|---|---|
| EP-1 | 3-glycidoxypropyl- trimethoxysilane | 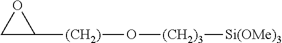 | Shin-Etsu Chemical |
| EP-2 | 4-(trimethoxysilyl)- butane-1,2-epoxide | 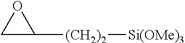 | Carbone Scientific |
| EP-3 | 8-oxysilan-2-yl- octyltriethoxysilane | 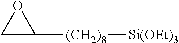 | SiKEMIA |
| EP-4 | 2-(3,4-epoxycyclo- hexyl)ethyltri- methoxysilane | 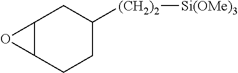 | Shin-Etsu Chemical |
| He | Hexyltrimethoxysilane | H₃C—(CH₂)₅—Si(OMe)₃ | Shin-Etsu Chemical |
| Ph | Phenyltriethoxysilane | 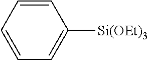 | Shin-Etsu Chemical |
| Ti-1 | Titanium i-propoxide | Ti—(OiPr)₄ | Kojundo Chemical Lab. |
| Ti-2 | Titanium methoxide | Ti—(OMe)₄ | Gelest |
| Ti-3 | Titanium n-nonyloxide | Ti—(O—C₉H₁₉)₄ | Gelest |

TABLE 12

| | Evaluation (1) |
|---|---|
| Condensate No. | Presence of formula- (1) structure |
| 1 | Yes |
| 2 | Yes |
| 3 | Yes |
| 4 | Yes |
| 5 | Yes |
| 6 | Yes |
| 7 | Yes |
| 8 | Yes |
| 9 | Yes |
| 10 | Yes |
| 11 | Yes |
| 12 | Yes |
| 13 | Yes |
| 14 | Yes |
| 15 | Yes |
| 16 | Yes |
| 17 | Yes |
| 18 | Yes |
| 19 | Yes |
| 20 | Yes |
| 21 | Yes |
| 22 | Yes |
| 23 | Yes |

(2) Production & Evaluation of Charging Rollers Charging rollers 2 to 23

A “mixture 2 of condensate 2, cyclic polysilane and photopolymerization initiator” to a “mixture 23 of condensate 23, cyclic polysilane and photopolymerization initiator” were prepared in the same way as the “mixture 1 of condensate 1, cyclic polysilane and photopolymerization initiator” except that, in preparing the “mixture 1 of condensate 1, cyclic polysilane and photopolymerization initiator”, the types of condensates and the amounts of cyclic polysilanes to be added were changed as shown in Table 13.

TABLE 13

| Mixture of | | |
|---|---|---|
| condensate, | | |
| photopolymerization | | |
| initiator and cyclic | | Cyclic |
| polysilane | Condensate | polysilane |
| No. | No. | (wt. %) |
| 1 | 1 | 0.5 |
| 2 | 2 | |
| 3 | 3 | |
| 4 | 4 | 12.0 |
| 5 | 5 | |
| 6 | 6 | |
| 7 | 7 | 1.0 |
| 8 | 8 | |
| 9 | 9 | |
| 10 | 10 | 5.0 |
| 11 | 11 | |
| 12 | 12 | |
| 13 | 13 | 10.0 |
| 14 | 14 | |
| 15 | 15 | |
| 16 | 16 | 5.0 |
| 17 | 17 | 5.0 |
| 18 | 18 | 5.0 |
| 19 | 19 | 5.0 |
| 20 | 20 | 5.0 |
| 21 | 21 | 5.0 |
| 22 | 22 | 5.0 |
| 23 | 23 | 5.0 |

Next, surface layer forming coating materials 2-1 to 2-3, 3-1 to 3-3, 4-1 to 4-3, 5-1 to 5-3, 6-1 to 6-3, 7-1 to 7-3, 8-1 to 8-3, 9-1 to 9-3, 10-1 to 10-3, 11-1 to 11-3, 12-1 to 12-3, 13-1 to 13-3, 14-1 to 14-3 and 15-1 to 15-3 were obtained in the same way as Example 1 except that the “mixture 2 of condensate 2, cyclic polysilane and photopolymerization initiator” to the “mixture 15 of condensate 15 and photopolymerization initiator”, respectively, were used. Charging rollers 2-1 to 2-3, 3-1 to 3-3, 4-1 to 4-3, 5-1 to 5-3, 6-1 to 6-3, 7-1 to 7-3, 8-1 to 8-3, 9-1 to 9-3, 10-1 to 10-3, 11-1 to 11-3, 12-1 to 12-3, 13-1 to 13-3, 14-1 to 14-3 and 15-1 to 15-3 were produced in the same way as the charging rollers 1-1 to 1-3 in Example 1 except that the above surface layer forming coating materials, respectively, were used.

About the “mixture 16 of condensate 16, cyclic polysilane and photopolymerization initiator” to the “mixture 23 of condensate 23, cyclic polysilane and photopolymerization initiator”, surface layer forming coating materials 16 to 23, respectively, were also prepared which each had a solid-matter concentration of 10% by mass.

About these surface layer forming coating materials, they were put to Evaluation (2).

Further, using the surface layer forming coating materials 16 to 23, charging rollers 16 to 23, respectively, were produced. These charging rollers were put to Evaluations (3) to (7). The results are shown in Tables 14-1 and 14-2.

TABLE 14-1

| | Surface | | | Evaluation | | | | |
|---|---|---|---|---|---|---|---|---|
| | layer | | | | | (5) | | |
| | forming | | Charg- | | | Presence of | | |
| | coating | Evalu- | ing | | | TiO_{4/2} and | | |
| Exam- | material | ation | roller | | (4) | Si—O—Ti | | |
| ple: | No. | (2) | No. | (3) | (μm) | linkage | (6) | (7) |
| 1 | 1-1 | A | 1-1 | A | 0.10 | Yes | B | C |
| | 1-2 | A | 1-2 | A | 1.00 | Yes | A | B |
| | 1-3 | A | 1-3 | A | 2.50 | Yes | A | B |
| 2 | 2-1 | A | 2-1 | A | 0.10 | Yes | A | C |
| | 2-2 | A | 2-2 | A | 1.00 | Yes | A | B |
| | 2-3 | A | 2-3 | B | 2.50 | Yes | A | B |
| 3 | 3-1 | B | 3-1 | A | 0.10 | Yes | A | C |
| | 3-2 | B | 3-2 | A | 1.00 | Yes | A | C |
| | 3-3 | C | 3-3 | B | 2.50 | Yes | A | C |
| 4 | 4-1 | A | 4-1 | A | 0.10 | Yes | B | C |
| | 4-2 | A | 4-2 | A | 1.00 | Yes | A | B |
| | 4-3 | A | 4-3 | A | 2.50 | Yes | A | B |
| 5 | 5-1 | A | 5-1 | A | 0.10 | Yes | A | C |
| | 5-2 | A | 5-2 | A | 1.00 | Yes | A | C |
| | 5-3 | A | 5-3 | B | 2.50 | Yes | A | B |
| 6 | 6-1 | A | 6-1 | A | 0.10 | Yes | A | C |
| | 6-2 | A | 6-2 | A | 1.00 | Yes | A | C |
| | 6-3 | A | 6-3 | B | 2.50 | Yes | A | C |
| 7 | 7-1 | A | 7-1 | A | 0.10 | Yes | B | A |
| | 7-2 | A | 7-2 | A | 1.00 | Yes | A | A |
| | 7-3 | A | 7-3 | A | 2.50 | Yes | A | A |
| 8 | 8-1 | A | 8-1 | A | 0.10 | Yes | A | A |
| | 8-2 | A | 8-2 | A | 1.00 | Yes | A | A |
| | 8-3 | A | 8-3 | B | 2.50 | Yes | A | A |
| 9 | 9-1 | B | 9-1 | A | 0.10 | Yes | A | B |
| | 9-2 | B | 9-2 | A | 1.00 | Yes | A | B |
| | 9-3 | C | 9-3 | B | 2.50 | Yes | A | B |
| 10 | 10-1 | A | 10-1 | A | 0.05 | Yes | C | A |
| | 10-2 | A | 10-2 | A | 1.00 | Yes | B | A |
| | 10-3 | A | 10-3 | A | 3.00 | Yes | A | A |

TABLE 14-2

| | Surface | | | Evaluation | | | | |
|---|---|---|---|---|---|---|---|---|
| | layer | | | | | (5) | | |
| | forming | | Charg- | | | Presence of | | |
| | coating | Evalu- | ing | | | TiO_{4/2} and | | |
| Exam- | material | ation | roller | | (4) | Si—O—Ti | | |
| ple: | No. | (2) | No. | (3) | (μm) | linkage | (6) | (7) |
| 11 | 11-1 | A | 11-1 | A | 0.05 | Yes | A | A |
| | 11-2 | A | 11-2 | A | 1.00 | Yes | A | A |
| | 11-3 | A | 11-3 | B | 3.00 | Yes | A | A |
| 12 | 12-1 | B | 12-1 | A | 0.05 | Yes | A | A |
| | 12-2 | B | 12-2 | A | 1.00 | Yes | A | B |
| | 12-3 | C | 12-3 | B | 3.00 | Yes | A | A |
| 13 | 13-1 | A | 13-1 | A | 0.10 | Yes | B | C |
| | 13-2 | A | 13-2 | A | 1.00 | Yes | A | B |
| | 13-3 | A | 13-3 | B | 2.50 | Yes | A | B |
| 14 | 14-1 | A | 14-1 | A | 0.10 | Yes | A | C |
| | 14-2 | A | 14-2 | A | 1.00 | Yes | A | B |
| | 14-3 | A | 14-3 | B | 2.50 | Yes | A | B |
| 15 | 15-1 | A | 15-1 | A | 0.10 | Yes | A | C |
| | 15-2 | A | 15-2 | A | 1.00 | Yes | A | C |
| | 15-3 | A | 15-3 | B | 2.50 | Yes | A | C |
| 16 | 16 | A | 16 | A | 1.00 | Yes | A | A |
| 17 | 17 | A | 17 | A | 1.00 | Yes | A | A |
| 18 | 18 | A | 18 | A | 1.00 | Yes | A | A |
| 19 | 19 | A | 19 | A | 1.00 | Yes | A | A |
| 20 | 20 | A | 20 | A | 1.00 | Yes | A | A |
| 21 | 21 | A | 21 | A | 1.00 | Yes | A | A |
| 22 | 22 | A | 22 | A | 1.00 | Yes | A | A |
| 23 | 23 | A | 23 | A | 1.00 | Yes | A | A |

### Comparative Examples 1 and 2

### (1) Preparation and Evaluation of Condensates 24 and 25 for Control

The condensates 3 and 1 shown in Table 10 were readied as condensates 24 and 25, respectively, for control.

Surface layer forming coating materials 24-1 to 24-3 and surface layer forming coating materials 25-1 to 25-3 were prepared in the same way as the method of preparing the surface layer forming coating materials in Example 1 except that these condensates were respectively used and that any cyclic polysilane was not added. These coating materials were put to Evaluation (2).

(2) Production and Evaluation of Charging Rollers 24 and 25

Charging rollers 24-1 to 24-3 and 25-1 to 25-3 were produced in the same way as the charging rollers 1-1 to 1-3 in Example 1 except that the above surface layer forming coating materials 24-1 to 24-3 and 25-1 to 25-3, respectively, were used. These charging rollers were put to Evaluations (3) to (7).

### Comparative Example 3

### (1) Preparation and Evaluation of Condensate 26 for Control

A condensate 26 was prepared in the same way as the condensate 1 in Example 1 except that it was composed as shown in Table 15 below.

### (2) Production and Evaluation of Charging Rollers 26-1 to 26-3

Surface layer forming coating materials 26-1 to 26-3 were prepared in the same way as the method of preparing the surface layer forming coating materials in Example 1 except that the condensate 26 were used and that any cyclic polysilane was not added. These coating materials were put to Evaluation (2).

TABLE 15

| | |
|---|---|
| Condensate | |
| intermediate | Component (C) |

| Condensate | | Amount | Ti-1 | |
|---|---|---|---|---|
| No. | No. | (g) | (g) | Ti/Si |
| 26 | 1 | 18.74 | 158.06 | 15.00 |

### Comparative Example 4

### Preparation and Evaluation of Condensate 27 for Control

Materials shown in Table 16 below were mixed, and then stirred at room temperature for 3 hours to prepare a condensate 27. This condensate 27 was put to Evaluation (2). Also, the condensate 27 already became milky and precipitated at the time of synthesis, and hence any surface layer forming coating material was not prepared and any charging roller was not produced.

TABLE 16

| | Component (C) | | |
|---|---|---|---|
| Condensate | Ti-1 | H₂O | Ethanol |
| No. | (g) | (g) | (g) |
| 26 | 88.1 | 2.02 | 83.81 |

The results of evaluation on the above Comparative Examples 1 to 4 are shown in Table 17.

Incidentally, about Comparative Example 3, the stability of the surface layer forming coating materials 26-1 to 26-3 was ranked “D” as shown in Table 17, and hence any charging roller was not produced. Thus, symbols “-” were given in the columns for Evaluations (3) to (7).

About Comparative Example 4, the condensate 27 already became milky and precipitated at the time of synthesis as stated above, and hence the stability of the surface layer forming coating material 27 was ranked “D” as shown in Table 17. Hence, any surface layer forming coating material was not prepared and any charging roller making use of the same was not produced. Thus, symbols “-” were given in the columns for Evaluations (3) to (7).

TABLE 17

| | Surface | | | Evaluation | | | | |
|---|---|---|---|---|---|---|---|---|
| | layer | | | | | (5) | | |
| | forming | | Charg- | | | Presence of | | |
| | coating | Evalu- | ing | | | TiO_{4/2} and | | |
| Comparative | material | ation | roller | | (4) | Si—O—Ti | | |
| Example: | No. | (2) | No. | (3) | (μm) | linkage | (6) | (7) |
| 1 | 24-1 | B | 24-1 | A | 0.10 | Yes | A | D |
| | 24-2 | B | 24-2 | A | 1.00 | Yes | A | D |
| | 24-3 | C | 24-3 | B | 2.50 | Yes | A | D |
| 2 | 25-1 | A | 25-1 | A | 0.10 | Yes | B | D |
| | 25-2 | A | 25-2 | A | 1.00 | Yes | A | D |
| | 25-3 | A | 25-3 | B | 2.50 | Yes | A | D |
| 3 | 26-1 | D | — | — | — | — | — | — |
| | 26-2 | D | — | — | — | — | — | — |
| | 26-3 | D | — | — | — | — | — | — |
| 4 | 27 | D | — | — | — | — | — | — |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2011-097477, filed on Apr. 25, 2011, which is herein incorporated by reference as part of this application.

### REFERENCE SIGNS LIST

101 substrate
102 conductive elastic layer
103 surface layer
21 image-bearing member (electrophotographic photosensitive member)
22 charging member (charging roller)
23 exposure means
24 developing means
24a toner-carrying member
24b agitating part
24c toner coat control member
25 transfer means
26 cleaning means
L exposure light
S2,S4 bias applying power source
P transfer material

What is claimed is:

1. A charging member for electrophotographic apparatus, the charging member comprising a substrate, an elastic layer and a surface layer,
wherein
said surface layer comprises:
a high-molecular compound having an Si—O—Ti linkage in the molecular structure, and
a cyclic polysilane represented by the following general formula (7);
and wherein
said high-molecular compound has a constituent unit represented by the following general formula (1) and a constituent unit represented by the following formula (2): 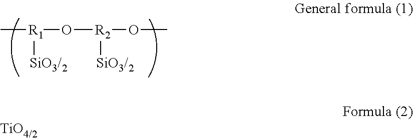
where, in the general formula (1), R₁ and R₂ each independently represent any structure selected from structures represented by the following general formulas (3) to (6): 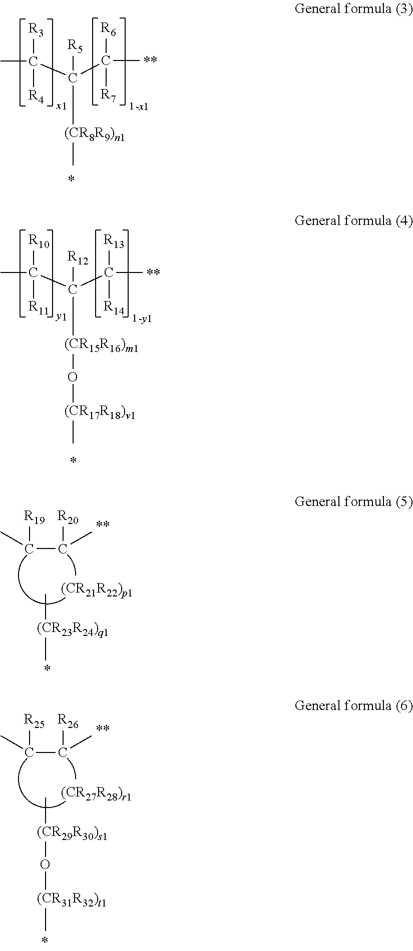
where, in the general formulas (3) to (6), R₃ to R₇, R₁₀ to R₁₄, R₁₉, R₂₀, R₂₅ and R₂₆ each independently represent a hydrogen atom, a straight-chain or branched-chain alkyl group having 1 to 4 carbon atom(s), a hydroxyl group, a carboxyl group or an amino group; R₈, R₉, R₁₅ to R₁₈, R₂₃, R₂₄ and R₂₉ to R₃₂ each independently represent a hydrogen atom or a straight-chain or branched-chain alkyl group having 1 to 4 carbon atom(s); R₂₁, R₂₂, R₂₇ and R₂₈ each independently represent a hydrogen atom, an alkoxy group having 1 to 4 carbon atom(s) or a straight-chain or branched-chain alkyl group having 1 to 4 carbon atom(s); n1, m1, q1, s1, t1 and v1 each independently represent an integer of 1 to 8, p1 and r1 each independently represent an integer of 4 to 12, and x1 and y1 each independently represent 0 or 1; and an asterisk * and a double asterisk ** each represent the position of bonding with the silicon atom and oxygen atom, respectively, in the general formula (1); and 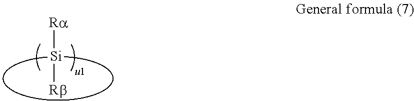
where, in the general formula (7), R_{α} and R_{β} each independently represent a hydrogen atom, a hydroxyl group, an alkyl group, an alkoxy group, an alkenyl group, a cycloalkyl group, a cycloalkyloxy group, a cycloalkenyl group, an aryl group, an aryloxy group or a silyl group; and u1 represent an integer of 4 to 12.

2. The charging member according to claim 1, wherein R₁ and R₂ in the general formula (1) each independently represent any structure selected from structures represented by the following general formulas (8) to (11): 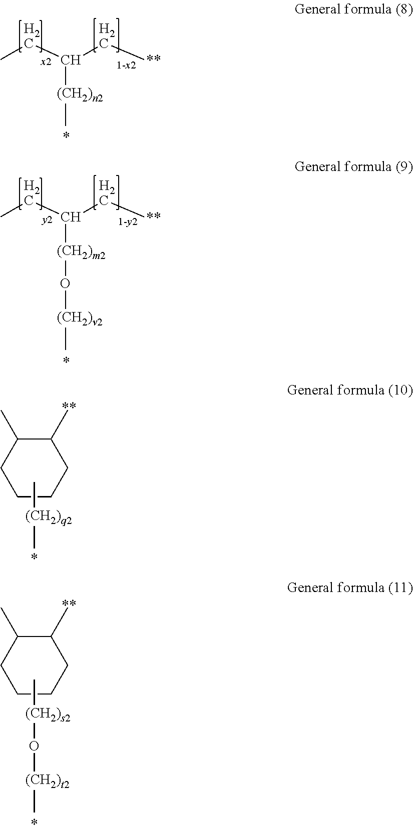
where, in the general formulas (8) to (11), n2, m2, q2, s2, t2 and v2 each independently represent an integer of 1 or more to 8 or less, and x2 and y2 each independently represent 0 or 1; and an asterisk * and a double asterisk ** each represent the position of bonding with the silicon atom and oxygen atom, respectively, in the general formula

3. The charging member according to claim 1, wherein R_{α} and R_{β} in the general formula (7) are both phenyl groups.

4. The charging member according to claim 1, wherein the cyclic polysilane represented by the general formula (7) is in a content of from 1.0 part by mass or more to 10.0 parts by mass or less, based on 100 parts by mass of the high-molecular compound having the Si—O—Ti linkage in the molecular structure.

5. The charging member according to claim 1, wherein the ratio of the number of atoms of titanium to that of silicon, Ti/Si, in the high-molecular compound is from 0.1 or more to 12.5 or less.

6. The charging member according to claim 1, wherein the high-molecular compound is a cross-linked product of a hydrolyzable compound having a structure represented by the following general formula (12) and a hydrolyzable compound having a structure represented by the following general formula (13):
R₃₃—Si(OR₃₄)(OR₃₅)(OR₃₆) General formula (12)
Ti(OR₃₇)(OR₃₈)(OR₃₉)(OR₄₀) General formula (13)
where, in the general formula (12), R₃₃ represents any structure selected from structures represented by the following general formulas (14) to (17) each; and R₃₄ to R₃₆ each independently represent a straight-chain or branched-chain alkyl group having 1 to 4 carbon atom(s); and, in the general formula (13), R₃₇ to R₄₀ each independently represent a straight-chain or branched-chain alkyl group having 1 to 9 carbon atom(s); and 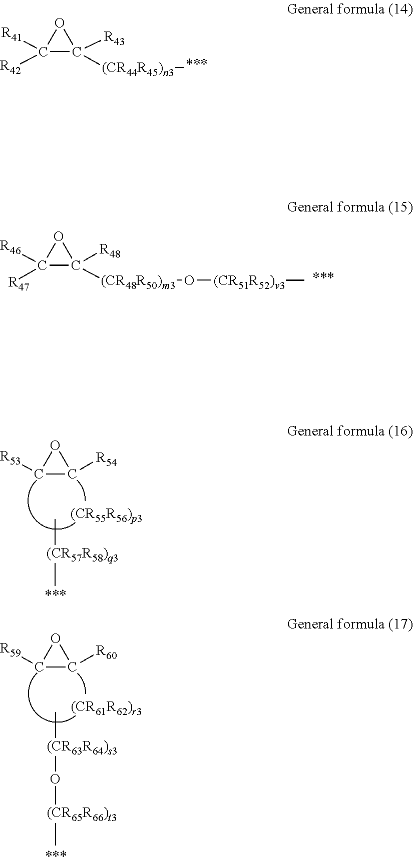
where, in the general formulas (14) to (17), R₄₁ to R₄₃, R₄₆ to R₄₈, R₅₃, R₅₄, R₅₉ and R₆₀ each independently represent a hydrogen atom, a straight-chain or branched-chain alkyl group having 1 to 4 carbon atom(s), a hydroxyl group, a carboxyl group or an amino group; R₄₄. R₄₅, R₄₉ to R₅₂, R₅₇, R₅₈ and R₆₃ to R₆₆ each independently represent a hydrogen atom or a straight-chain or branched-chain alkyl group having 1 to 4 carbon atom(s); R₅₅, R₅₆, R₆₁ and R₆₂ each independently represent a hydrogen atom, an alkoxy group having 1 to 4 carbon atom(s) or a straight-chain or branched-chain alkyl group having 1 to 4 carbon atom(s); n3, m3, q3, s3, t3 and v3 each independently represent an integer of 1 to 8, and p3 and r3 each independently represent an integer of 4 to 12; and a triple asterisk *** represents the position of bonding with the silicon atom in the formula (12).

7. The charging member according to claim 1, wherein the high-molecular compound is a cross-linked product of a hydrolyzable compound having a structure represented by the following general formula (12), a hydrolyzable compound having a structure represented by the following general formula (13) and a hydrolyzable compound having a structure represented by the following general formula (18);
R₃₃—Si(OR₃₄)(OR₃₅)(OR₃₆) General formula (12)
Ti(OR₃₇)(OR₃₈)(OR₃₉)(OR₄₀) General formula (13)
where, in the general formula (12), R₃₃ represents any structure selected from structures represented by the following general formulas (14) to (17) each; and R₃₄ to R₃₆ each independently represent a straight-chain or branched-chain alkyl group having 1 to 4 carbon atom(s); and, in the general formula (13), R₃₇ to R₄₀ each independently represent a straight-chain or branched-chain alkyl group having 1 to 9 carbon atom(s); 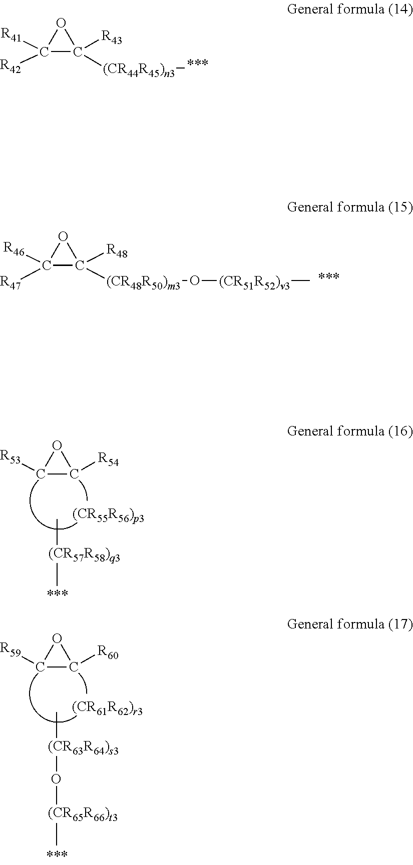
where, in the general formulas (14) to (17), R₄₁ to R₄₃, R₄₆ to R₄₈, R₅₃, R₅₄, R₅₉ and R₆₀ each independently represent a hydrogen atom, a straight-chain or branched-chain alkyl group having 1 to 4 carbon atom(s), a hydroxyl group, a carboxyl group or an amino group; R₄₄, R₄₅. R₄₉ to R₅₂, R₅₇, R₅₈ and R₆₃ to R₆₆ each independently represent a hydrogen atom or a straight-chain or branched-chain alkyl group having 1 to 4 carbon atom(s); R₅₅, R₅₆, R₆₁ and R₆₂ each independently represent a hydrogen atom, an alkoxy group having 1 to 4 carbon atom(s) or a straight-chain or branched-chain alkyl group having 1 to 4 carbon atom(s); n3, m3, q3, s3, t3 and v3 each independently represent an integer of 1 to 8, and p3 and r3 each independently represent an integer of 4 to 12; and a triple asterisk *** represents the position of bonding with the silicon atom in the formula (12); and
R₆₇—Si(OR₆₈)(OR₆₉)(OR₇₀) General formula (18)
where, in the formula (18), R₆₇ represents a straight-chain or branched-chain alkyl group having 1 to 4 carbon atom(s) or a phenyl group; and R₆₈ to R₇₀ each independently represent a straight-chain or branched-chain alkyl group having 1 to 6 carbon atom(s).

8. An electrophotographic apparatus comprising an electrophotographic photosensitive member and a charging member disposed in contact with the electrophotographic photosensitive member;
the charging member being the charging member according to claim 1.

9. A process cartridge which comprises an electrophotographic photosensitive member and a charging member disposed in contact with the electrophotographic photosensitive member, and is so set up as to be detachably mountable to the main body of an electrophotographic apparatus;
the charging member being the charging member according to claim 1.
